(19) United States
(12) Patent Application Publication
(10) Pub. No.: US 2026/0347515 A1
(43) Pub. Date: Nov. 5, 2026

(54) RUTHENIUM COMPLEX COMPOUND, CATALYST COMPRISING SAME, AND METHOD FOR SYNTHESIZING RUTHENIUM COMPLEX COMPOUND

(71) Applicant: POSTECH RESEARCH AND BUSINESS DEVELOPMENT FOUNDATION, Pohang-si (KR)

(72) Inventors: Eunsung LEE, Pohang-si (KR); Hayoung SONG, Pohang-si (KR); Minjae JANG, Pohang-si (KR)

(73) Assignee: POSTECH RESEARCH AND BUSINESS DEVELOPMENT FOUNDATION, Pohang-si (KR)

(21) Appl. No.: 19/476,246

(22) PCT Filed: Jun. 18, 2024
(86) PCT No.: PCT/KR2024/008384

§ 371 Date: Oct. 17, 2025

(30) Foreign Application Priority Data
Jun. 20, 2023 (KR) 10-2023-0078931
Jun. 17, 2024 (KR) 10-2024-0078479

(51) Int. Cl. C08F 4/82; C07F 15/00

(52) U.S. Cl. CPC C08F 4/82; C07F 15/0046

(57) ABSTRACT

Disclosed are a ruthenium complex compound, a catalyst including the same, and a synthesis method for the ruthenium complex compound. The ruthenium complex compound may be represented by Formula 1.

### TECHNICAL FIELD

The present disclosure relates to a ruthenium complex compound, a catalyst including the same, and a synthesis method for the ruthenium complex compound.

### BACKGROUND ART

A cyclic polymer has a structure in which the ends of the polymer chain are linked to each other. Unlike linear polymers, cyclic polymers exhibit physical properties such as small molecular dynamic volume, low intrinsic viscosity, and high glass transition temperature. Due to these characteristics, cyclic polymers have attracted considerable attention as bio-based materials and next-generation polymer materials.

The synthesis of cyclic polymers utilizes metal complex compound catalysts for ring expansion polymerization. For example, metal complex compound catalysts for ring expansion polymerization may include metal complex compounds based on cyclic alkyl(amino)carbenes, metal complex compounds based on N-heterocyclic carbenes (NHCs), and the like.

When used as catalysts, metal complex compounds based on cyclic alkyl(amino)carbenes exhibit both stronger nucleophilicity and stronger electrophilicity than metal complex compounds based on N-heterocyclic carbene (NHCs), demonstrating superior activity than general catalysts. However, conventional metal complex compounds based on cyclic alkyl(amino)carbenes face limitations in enabling the large-scale synthesis of cyclic polymers using a single-step reaction.

Accordingly, there remains a need for a novel metal complex compound, a catalyst including the same, and the novel metal complex compound.

### DISCLOSURE OF INVENTION

### Technical Problem

An aspect is to provide a novel ruthenium complex compound.

Another aspect is to provide a catalyst including the ruthenium complex compound.

Another aspect is to provide a synthesis method for the ruthenium complex compound.

### Solution to Problem

According to an aspect,
a ruthenium complex compound represented by Formula 1 below is provided:

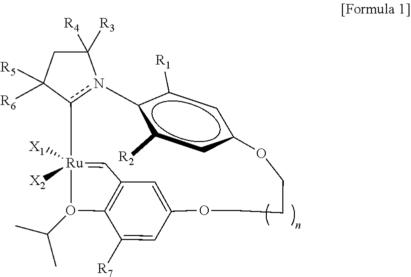

In the formula,
n may be an integer of 1 to 20;
R₁, R₂, R₃, and R₄ may each independently be a substituted or unsubstituted C₁-C₁₀ alkyl group;
R₅, R₆, and R₇ may each independently be a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof;
the substitution may be one in which one hydrogen atom of the hydrogen atoms in R₁, R₂, R₃, R₄, R₅, R₆, and R₇ is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-C₃₀ aryl C₃-C₃₀ heteroaryl group, or a combination thereof; and
X₁ and X₂ may each independently be a halogen atom, a substituted benzenethiol ligand, a substituted benzopyrazine ligand, or a combination thereof, and
the substituent may be one in which one hydrogen atom of the hydrogen atoms in X₁ or X₂ is independently substituted with a halogen group, a thiol group, a dithiol group, an amino group, or a combination thereof.

According to another aspect,
a catalyst including the ruthenium complex compound is provided.

According to another aspect,
a synthesis method for a ruthenium complex compound is provided, the method including: reacting a cyclic (alkyl)(amino)carbene linked with an isopropoxystyrene, which is represented by Formula 9 below, with a ruthenium precursor to synthesize the ruthenium complex compound:

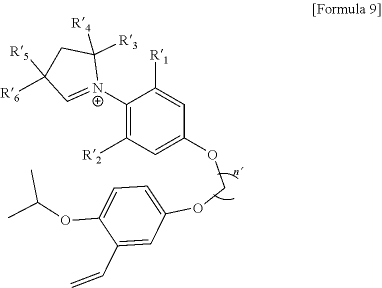

In the formula,
n′ may be an integer of 1 to 20;
R′₁, R′₂, R′₃, and R′₄ may each independently be a substituted or unsubstituted C₁-C₁₀ alkyl group;
R′₅ and R′₆ may each independently be a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof;
the substitution may be one in which one hydrogen atom of the hydrogen atoms in R′₁, R′₂, R′₃, R′₄, R′₅, and R′₆ is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-C₃₀ aryl C₃-C₃₀ heteroaryl group, or a combination thereof; and
X′ may be Cl⁻, Br⁻, I⁻, NO₃⁻, BF₄⁻, CF₃SO₃⁻, C₃₂H₁₂BF₂₄⁻, (C₆F₅)₃B⁻, or a combination thereof.

### Advantageous Effects of Invention

The ruthenium complex compound according to an aspect is represented by Formula 1 above. The ruthenium complex compound can provide a complex compound which permits the introduction of various steric hindrances and exhibits excellent thermal stability. The ruthenium complex compound is used as a catalyst for ring expansion metathesis polymerization, thereby enabling the large-scale synthesis of cyclic polymers under a simple single-step reaction.

### BRIEF DESCRIPTION OF DRAWINGS

FIG. 1A is a ¹H nuclear magnetic resonance (NMR) spectrum of Compound Ru-1 prepared in Example 1; and FIG. 1B is a ¹³C NMR spectrum of Compound Ru-1 prepared in Example 1.

FIG. 2A is a ¹H NMR spectrum of Compound Ru-2 prepared in Example 2; and FIG. 2B is a ¹³C NMR spectrum of Compound Ru-2 prepared in Example 2.

FIG. 3A is a ¹H NMR spectrum of Compound Ru-3 prepared in Example 3; and FIG. 3B is a ¹³C NMR spectrum of Compound Ru-3 prepared in Example 3.

FIG. 4A is a ¹H NMR spectrum of Compound Ru-4 prepared in Example 4; and FIG. 4B is a ¹³C NMR spectrum of Compound Ru-4 prepared in Example 4.

FIG. 5A is a ¹H NMR spectrum of Compound Ru-5 prepared in Example 5; and FIG. 5B is a ¹³C NMR spectrum of Compound Ru-5 prepared in Example 5.

FIG. 6A is a ¹H NMR spectrum of Compound Ru-6 prepared in Example 6; and FIG. 6B is a ¹³C NMR spectrum of Compound Ru-6 prepared in Example 6.

FIG. 7A is a ¹H NMR spectrum of Compound Ru-7 prepared in Example 7; and FIG. 7B is a ¹³C NMR spectrum of Compound Ru-7 prepared in Example 7.

FIG. 8 is a graph showing the analysis results of a thermal stability test for Compounds Ru-1, Ru-4, Ru-5, and Ru-6 prepared in Example 1, Example 4, Example 5, and Example 6, and for Compound UltraNitroCat-1 of Reference Example 1.

### BEST MODE FOR CARRYING OUT THE INVENTION

### Mode for the Invention

Hereinafter, a ruthenium complex compound, a catalyst including the same, and a synthesis method for the ruthenium complex compound according to an embodiment of the present disclosure will be described in detail with reference to the accompanying drawings. The following examples are provided for illustrative purposes only and do not limit the present disclosure, which is defined solely by the scope of the appended claims.

Throughout this specification, singular expressions encompass plural expressions unless the context clearly indicates otherwise. When a component is described as “comprising” or “including” a particular element, this means that other elements may be further included rather than excluded, unless specifically stated to the contrary.

As used herein, the term “combination” encompasses both selective combinations and combinations of all previously listed components, unless specifically stated otherwise.

The term “or” means “and/or” unless otherwise specified.

Throughout this specification, terms such as “an embodiment,” “embodiment,” “an exemplary embodiment,” and “an exemplary example” indicate that a particular feature described in connection with the embodiment is included in at least one embodiment described herein and may or may not be present in other embodiments.

It should be understood that the described features may be combined in any suitable manner across various embodiments. Unless otherwise defined, all technical and scientific terms used herein have the same meaning as commonly understood by one of ordinary skill in the art to which this application pertains. All patents, patent applications, and other references cited herein are incorporated by reference in their entirety. However, in the event of any inconsistency or conflict between the terms of this specification and the terms of an incorporated reference, the terms of this specification shall take precedence. While specific examples and embodiments have been described above, it will be apparent to those skilled in the art that alternatives, modifications, variations, improvements, and substantial equivalents that are currently unforeseen may become apparent to the applicant or others skilled in the art. Accordingly, the appended claims are intended to embrace all such alternatives, modifications, variations, improvements, and substantial equivalents.

Methods for synthesizing cyclic polymers are classified into a ring-closing reaction and a ring expansion polymerization reaction. In the case of a ring-closing reaction, a low-concentration solution must be used to avoid the occurrence of unwanted polymerization reactions between polymer chains as a side reaction. For this reason, the ring-closing reaction has limitations in terms of large-scale synthesis for industrial applications.

On the other hand, although the ring expansion polymerization reaction allows for the large-scale synthesis of cyclic polymers with a simpler synthesis method compared to the ring-closing reaction, it must be possible to selectively obtain a polymer having a desired molecular weight with a low polydispersity (PDI).

Focusing on this point, the present inventors intend to propose a novel ruthenium complex compound, a catalyst including the same, and a synthesis method for the ruthenium complex compound.

According to an embodiment, a ruthenium complex compound represented by Formula 1 below is provided:

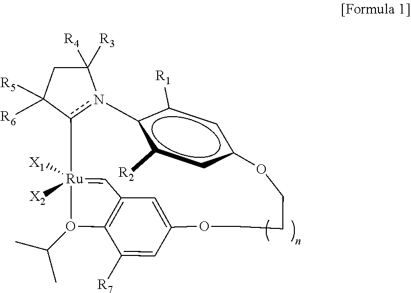

In the formula,
n may be an integer of 1 to 20;
R₁, R₂, R₃, and R₄ may each independently be a substituted or unsubstituted C₁-C₁₀ alkyl group;
R₅, R₆, and R₇ may each independently be a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof;
the substitution may be one in which one hydrogen atom of the hydrogen atoms in R₁, R₂, R₃, R₄, R₅, R₆, and R₇ is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-C₃₀ aryl C₃-C₃₀ heteroaryl group, or a combination thereof; and
X₁ and X₂ may each independently be a halogen atom, a substituted benzenethiol ligand, a substituted benzopyrazine ligand, or a combination thereof, and
the substituent may be one in which one hydrogen atom of the hydrogen atoms in X₁ or X₂ is independently substituted with a halogen group, a thiol group, a dithiol group, an amino group, or a combination thereof.

The ruthenium complex compound according to an embodiment may provide a complex compound into which varied steric hindrance can be introduced and which has excellent thermal stability. This ruthenium complex compound is used as a catalyst for ring expansion metathesis polymerization, thereby enabling the large-scale synthesis of cyclic polymers using a simple single-step reaction.

According to an embodiment, in Formula 1, n may be an integer of 1 to 20, an integer of 5 to 12, or an integer of 5 to 10. If n is within the above range, appropriate strain may be maintained between the benzene ring and the heterocyclic ring linked by the alkylene group, and the ruthenium complex compound may have excellent activity as a catalyst for cyclic polymer synthesis.

According to an embodiment, in Formula 1, R₁, R₂, R₃, and R₄ may each independently be a substituted or unsubstituted C₁-C₅ alkyl group. In Formula 1, the benzene ring having R₁ and R₂ substituents may exhibit superior catalytic activity compared to benzene rings substituted with linear groups.

According to an embodiment, in Formula 1, R₁ and R₂ may be the same group.

According to an embodiment, in Formula 1, at least one of R₅, R₆, and R₇ may be a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof.

The cyclic (alkyl)(amino)carbene bearing R₅ and R₆ substituents has both strong nucleophilic and electrophilic character. As a result, the cyclic (alkyl)(amino)carbene exhibits a small singlet-triplet energy gap and may thus show excellent catalytic activity. In addition, the cyclic (alkyl)(amino)carbene exhibits greater resistance to oxygen (O₂) or water (H₂O) than conventional catalysts, and is less prone to side reactions. Furthermore, a cyclic (alkyl)(amino)carbene having a chiral center may be used to synthesize cyclic polymers of various structures through an asymmetric reaction.

According to an embodiment, in Formula 1, at least one of R₆ and R₇ may be a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof.

According to an embodiment, in Formula 1, X₁ and X₂ may be a halogen atom. For example, in Formula 1, X₁ and X₂ may be a Cl, Br, or I atom.

According to an embodiment, an example of the substituted benzenethiol ligand may include 3,6-dichloro-1,2-benzenethiol.

According to an embodiment, an example of the substituted benzopyrazine (i.e., quinoxaline) ligand may include 2,3-dithiol-benzopyrazine.

According to an embodiment, the ruthenium complex compound may include one or more of complex compounds represented by Formulas 2 to 8 below:

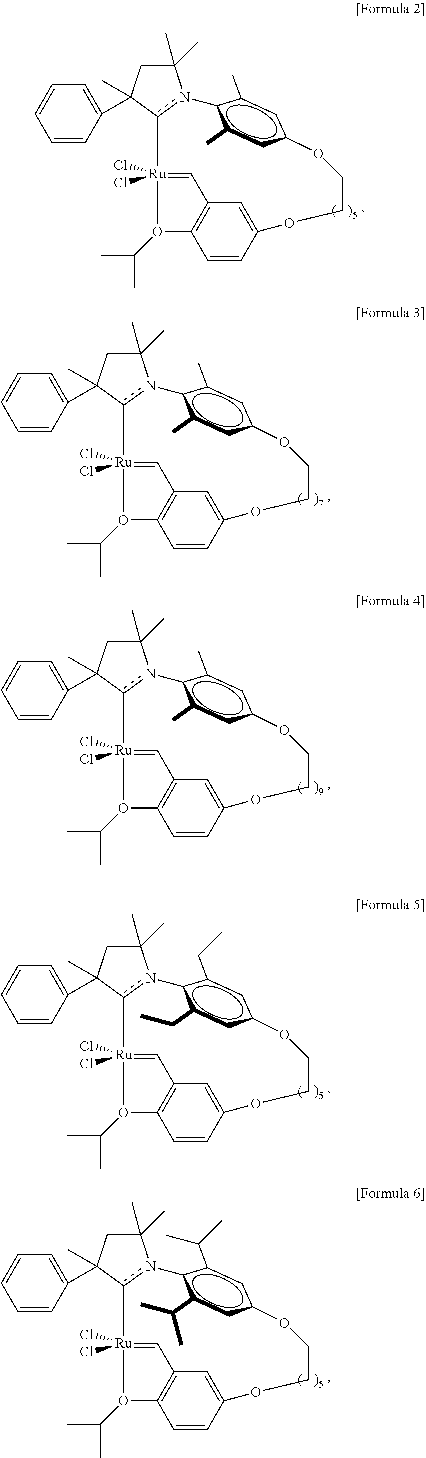

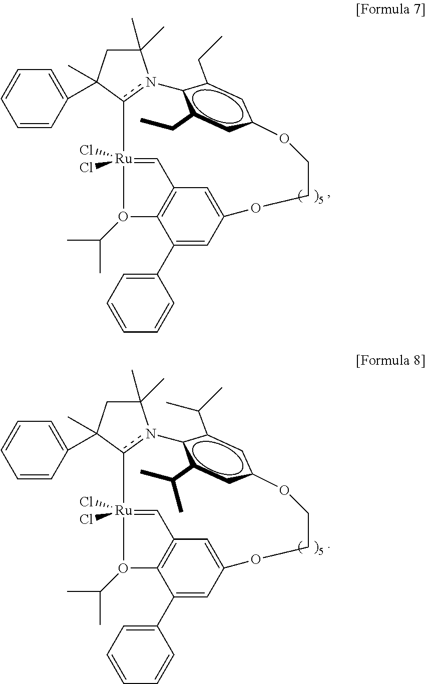

According to an embodiment, the ruthenium complex compound may have a monoclinic crystal structure, a triclinic crystal structure, or a combination thereof, and may have a P−1 space group, a P2₁/c space group, a P2₁/n space group, or a combination thereof.

According to another embodiment, a catalyst including the aforementioned ruthenium complex compound is provided. The catalyst may enable the large-scale synthesis of cyclic polymers by a simple single-step reaction.

According to an embodiment, the catalyst may be used for ring expansion metathesis polymerization. In ring expansion metathesis polymerization, cyclic polymers may be made by intermolecular chain transfer using the catalyst. Ring expansion metathesis polymerization involves a mechanism similar to backbiting in linear ring-opening metathesis polymerization (ROMP). Intermolecular chain transfer may occur even before the complete consumption of monomers. Accordingly, the aforementioned catalyst, which enables the introduction of diverse steric hindrance and provides excellent thermal stability, may facilitate the synthesis of high-density cyclic polymers via ring expansion metathesis polymerization.

According to an embodiment, the catalyst may have a micelle shape, a nanoparticle shape, or a combination shape thereof. However, the catalyst is not limited to the aforementioned shapes and may be prepared in various shapes in the art.

According to an embodiment, the catalyst may be used as a lubricant or a coating agent.

According to another embodiment, a synthesis method for a ruthenium complex compound is provided, the method including: synthesizing the ruthenium complex compound according to claim 1: by a reaction of a ruthenium precursor with a cyclic (alkyl)(amino)carbene represented by Formula 9 and linked with an isopropoxystyrene

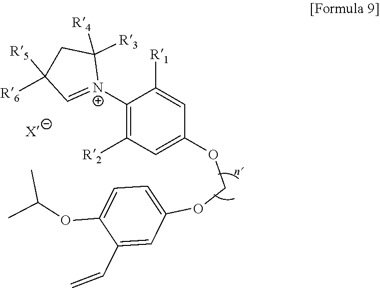

In the formula,
n′ may be an integer of 1 to 20;
R′₁, R′₂, R′₃, and R′₄ may each independently be a substituted or unsubstituted C₁-C₁₀ alkyl group;
R′₅ and R′₆ may each independently be a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof;
the substitution may be one in which one hydrogen atom of the hydrogen atoms in R′₁, R′₂, R′₃, R′₄, R′₅, and R′₆ is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-30 arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-30 aryl C₃-C₃₀ heteroaryl group, or a combination thereof; and
X′ may be Cl⁻, Br⁻, I⁻, NO₃⁻, BF₄⁻, CF₃SO₃⁻, C₃₂H₁₂BF₂₄⁻, (C₆F₅)₃B⁻, or a combination thereof.

According to an embodiment, the synthesis method for the ruthenium complex compound may enable the large-scale synthesis of cyclic polymers by a simple single-step reaction.

According to an embodiment, in Formula 9, n′ may be an integer of 1 to 20, an integer of 5 to 12, or an integer of 5 to 10. If n′ is within the above range, appropriate strain may be maintained between the benzene ring and the heterocyclic ring linked by the alkylene group, and the resulting complex compound may have excellent activity as a catalyst for cyclic polymer synthesis.

According to an embodiment, the ruthenium precursor may include the precursor represented by Formula 10 below:

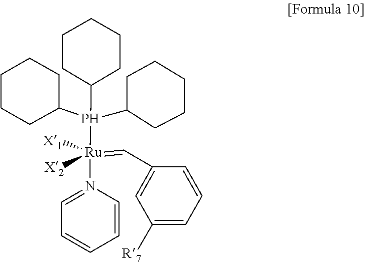

In the formula,
R₇ may be a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof; and
the substitution may be one in which one hydrogen atom of the hydrogen atoms is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-C₃₀ aryl C₃-C₃₀ heteroaryl group, or a combination thereof.

According to an embodiment, the synthesis of the ruthenium complex compound may include synthesizing the ruthenium complex compound by stirring for at least 48 hours at a temperature of 25° C. to 70° C. For example, the synthesis of the ruthenium complex compound may include a first process of stirring for 24 hours at a temperature of 25° C. to 40° C. and a second process of stirring for 24 hours at a temperature of 70° C.

In the present specification, the definitions for the substituents of Formula 1, Formula 9, and Formula 10 are as follows.

An alkyl group refers to a group of a fully saturated branched or unbranched (or straight-chain or linear) hydrocarbon. Non-limiting examples of the alkyl group may include methyl, ethyl, n-propyl, isopropyl, n-butyl, isobutyl, sec-butyl, n-pentyl, isopentyl, neopentyl, iso-amyl, n-hexyl, 3-methylhexyl, 2,2-dimethylpentyl, 2,3-dimethylpentyl, and n-heptyl. One or more hydrogen atoms of the alkyl may be substituted with the aforementioned substituents.

A cycloalkyl group refers to an aliphatic hydrocarbon including one or more rings. Herein, the alkyl group is as described above.

An aryl group, used alone or in combination, means an aromatic hydrocarbon including one or more rings. The aryl group also includes a group in which an aromatic ring is fused to one or more cycloalkyl rings. Non-limiting examples of the aryl include a phenyl group, a naphthyl group, and a tetrahydronaphthyl group. In addition, one or more hydrogen atoms of the aryl group may be substituted with the same substituents as in the case of the aforementioned alkyl group.

A heteroaryl group refers to a monocyclic or bicyclic organic compound that includes one or more heteroatoms selected from N, O, P, or S, and in which the remaining ring atoms are carbon. The heteroaryl group, for example, may include 1 to 5 heteroatoms and may include 5 to 10 ring members. The S or N may be oxidized to have various oxidation states. Examples of the monocyclic heteroaryl group may include a thienyl group, a furyl group, a pyrrolyl group, an imidazolyl group, a pyrazolyl group, a thiazolyl group, an isothiazolyl group, a 1,2,3-oxadiazolyl group, a 1,2,4-oxadiazolyl group, a 1,2,5-oxadiazolyl group, a 1,3,4-oxadiazolyl group, a 1,2,3-thiadiazolyl group, a 1,2,4-thiadiazolyl group, a 1,2,5-thiadiazolyl group, a 1,3,4-thiadiazolyl group, an isothiazol-3-yl group, an isothiazol-4-yl group, an isothiazol-5-yl group, an oxazol-2-yl group, an oxazol-4-yl group, an oxazol-5-yl group, an isoxazol-3-yl group, an isoxazol-4-yl group, an isoxazol-5-yl group, a 1,2,4-triazol-3-yl group, a 1,2,4-triazol-5-yl group, a 1,2,3-triazol-4-yl group, a 1,2,3-triazol-5-yl group, a tetrazolyl group, a pyrid-2-yl group, a pyrid-3-yl group, a 2-pyrazin-2-yl group, a pyrazin-4-yl group, a pyrazin-5-yl group, a 2-pyrimidin-2-yl group, a 4-pyrimidin-2-yl group, or a 5-pyrimidin-2-yl group. Heteroaryl groups may include heteroaromatic rings fused with one or more aryl groups, cycloaliphatic rings, or other heterocyclic rings. Examples of the bicyclic heteroaryl include indolyl, isoindolyl, indazolyl, indolizinyl, purinyl, quinolizinyl, quinolinyl, and isoquinolinyl. One or more hydrogen atoms of such a heteroaryl may be substituted with the same substituents as in the case of the aforementioned alkyl group.

A halogen group is —F, —Cl, —Br, or —I.

A hydroxy group is —OH.

A nitro group is —NO₂.

A cyano group is —CN.

An amino group is —NH₂.

A thiol group is —SH.

An alkylamino group refers to an amino group in which one or more hydrogen atoms are substituted with an alkyl group. Here, the alkyl group is as described above.

An arylamino group refers to an amino group in which one or more hydrogen atoms are substituted with an aryl group. Here, the aryl group is as described above.

An arylsilyl group refers to a silyl group in which one or more hydrogen atoms are substituted with an aryl group. Here, the silyl group is —SiH₃, and the aryl group is as described above.

An alkylarylsilyl group refers to a silyl group in which one or more hydrogen atoms are substituted with an alkyl group and an aryl group. Here, the silyl group is —SiH₃, and the alkyl group and the aryl group are as described above.

A haloalkyl group refers to an alkyl group substituted with a halogen atom. Here, the alkyl group is as described above.

An arylalkyl group refers to an alkyl group in which one or more hydrogen atoms are substituted with an aryl group. Here, the alkyl group is as described above.

An alkoxy group refers to an alkyl group bonded to an oxygen. Examples of the alkoxy group may include methoxy, ethoxy, and propoxy.

An alkylaryl group refers to an aryl group in which one or more hydrogen atoms are substituted with an alkyl group. Here, the alkyl group and the aryl group are as described above.

An aryloxy group refers to an aryl group bonded to an oxygen. An example of the aryloxy group may include a phenoxy group. Here, the aryl group is as described above.

An alkylheteroaryl group refers to a heteroaryl group in which one or more hydrogen atoms are substituted with an alkyl group. Here, the alkyl group and the heteroaryl group are as described above.

An arylheteroaryl group refers to a heteroaryl group in which one or more hydrogen atoms are substituted with an aryl group. Here, the aryl group and the heteroaryl group are as described above.

The following Examples and Comparative Examples are provided to illustrate the present disclosure. However, these Examples are merely exemplary and are not intended to limit the scope of the present disclosure.

### EXAMPLES

All air- and moisture-sensitive manipulations were performed under an N₂ atmosphere. Toluene was used after being distilled from sodium benzophenone ketyl. Acetonitrile was used after being distilled from P₂O₅. Chloroform-di and acetonitrile-d₃ were dried using activated 3 Å molecular sieves. 4-amino-3,5-diethylphenol was prepared according to Adv. Synth. Catal. 2014, 356, 460-474. 4-amino-3,5-bis(1-methylethyl)phenol was prepared according to Organic Letters 2007, 9, 3845-3848. 3-ethenyl-4-(1-methylethoxy) phenol was prepared according to Organometallics 2014, 33, 338-346. rac-2,4-dimethyl-2-phenylpent-4-enal was prepared according to The Journal of Organic Chemistry 2022, 87, 3511-3518. The ruthenium precursor (1st generation Grubbs complex) was prepared according to Inorganica Chimica Acta 2008, 361, 1059-1065. All other chemicals were purchased from commercial suppliers and used as received. All deuterated solvents were purchased from Cambridge Isotope Laboratories.

¹H NMR spectra, proton-decoupled ¹³C NMR spectra (¹³C{¹H}), and proton-decoupled 19F NMR spectra (19F{¹H}) were recorded using a Bruker DRX 500 spectrometer, a Bruker Avance III HD 500, and a Varian/Oxford As-500. Chemical shifts for ¹H and ¹³C acquisition were referenced to the residual solvent peaks (¹H: CDCl₃, δ=7.26; CD₃CN, δ=1.94; C₆D₆, δ=7.16 ppm, ¹³C: CDCl₃, δ=77.16; CD₃CN, δ=118.26 ppm). High-resolution mass spectrometry was performed at the Korea Basic Science Institute using a JEOL JMS 700 high-resolution mass spectrometer.

### Examples 1 to 7: Preparation of Ruthenium Complex Compounds (Complex Compounds Ru-1 to Ru-7)

Complex Compounds Ru-1 to Ru-7 were each prepared according to the processes of the reaction scheme below.

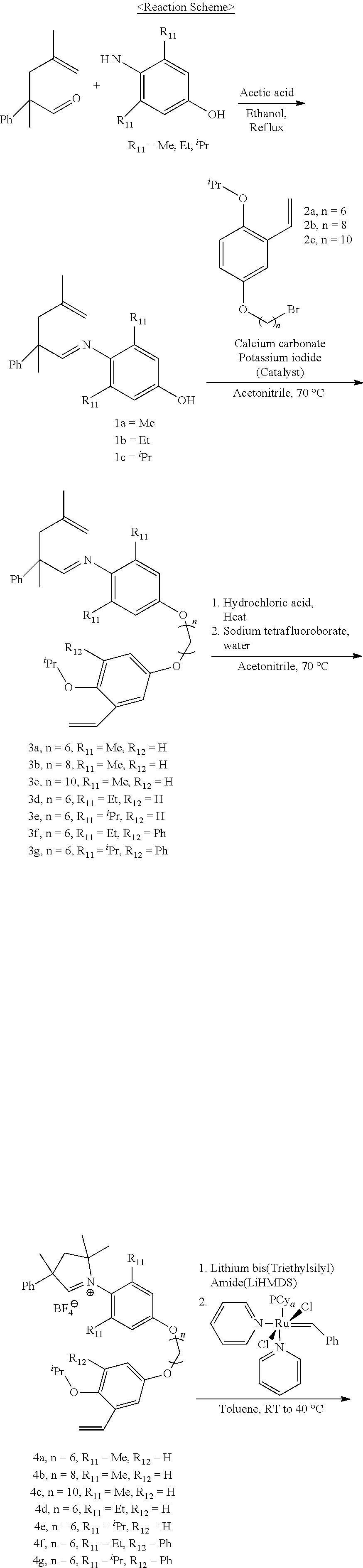

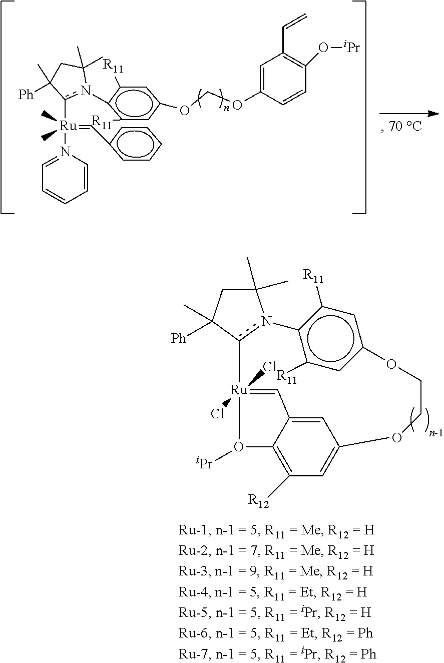

### (Process 1) Preparation of Compounds 1a to 1c

Under an air atmosphere, rac-2,4-dimethyl-2-phenylpent-4-enal (1.05 eq.), aminophenol (1.00 eq.), and acetic acid (AcOH, 0.05 eq.) were placed in a round-bottom flask, and ethanol was added to obtain a reaction mixture. The reaction mixture was then refluxed for 24 hours. The reaction mixture was cooled to room temperature, and the solvent was concentrated in a vacuum to obtain a product. The product was washed with cold methanol and pentane and dried in a vacuum to obtain light-brown solid compounds (1a, 1b, and 1c).

Compound 1a (R₁₁=Me, 2.49 g, 52%)

¹H NMR (500 MHz, CD₃CN): δ (ppm) 7.69 (s, 1H), 7.47 (d, J=7.8 Hz, 2H), 7.36 (t, J=7.6 Hz, 2H), 7.25 (t, J=7.3 Hz, 1H), 6.45 (s, 2H), 6.42 (s, 1H), 4.78 (s, 1H), 4.62 (s, 1H), 2.85 (dd, J=36.6, 13.9 Hz, 2H), 1.96 (s, 6H), 1.60 (s, 3H), 1.35 (s, 3H).

¹³C NMR (125 MHz, CD₃CN): δ (ppm) 173.6, 153.5, 144.8, 144.4, 143.8, 129.2, 129.1, 128.3, 127.4, 115.4, 115.3, 48.4, 47.7, 24.6, 22.4, 18.6.

HRMS (EI) for C₂₁H₂₅NO (M⁺): calc.: 307.1936, found: 307.1938.

Compound 1b (R₁₁=Et, 4.66 g, 82%)

¹H NMR (500 MHz, CD₃CN): δ (ppm) 7.66 (s, 1H), 7.47 (d, J=8.3 Hz, 2H), 7.37 (t, J=7.8 Hz, 2H), 7.26 (t, J=7.3 Hz, 1H), 6.47 (s, 2H), 6.45 (s, 1H), 4.77 (s, 1H), 4.62 (s, 1H), 2.94 (d, J=14.0 Hz, 1H), 2.78 (d, J=14.0 Hz, 1H), 2.32 (q, J=7.5 Hz, 4H), 1.60 (s, 3H), 1.33 (s, 3H), 1.00 (t, J=7.5 Hz, 6H).

¹³C NMR (125 MHz, CD₃CN): δ (ppm) 173.1, 153.9, 144.5, 143.8, 143.5, 135.4, 129.2, 128.3, 127.5, 115.3, 113.9, 48.4, 47.5, 25.3, 24.6, 22.0, 15.1.

HRMS (EI) for C₂₃H₂₉NO (M⁺): calc.: 335.2249, found: 335.2246.

Compound 1c (R₁₁=ⁱPr, 3.65 g, 92%)

¹H NMR (500 MHz, CD₃CN): δ (ppm) 7.63 (s, 1H), 7.47 (d, J=8.3 Hz, 2H), 7.37 (t, J=7.8 Hz, 2H), 7.26 (t, J=7.3 Hz, 1H), 6.53 (s, 2H), 6.43 (s, 1H), 4.78 (s, 1H), 4.62 (s, 1H), 2.96 (d, J=14.0 Hz, 1H), 2.86-2.77 (m, 3H), 1.61 (s, 3H), 1.34 (s, 3H), 1.05 (d, J=6.9 Hz, 6H), 1.02 (d, J=6.9 Hz, 6H).

¹³C NMR (125 MHz, CD₃CN): δ (ppm) 173.3, 154.3, 144.5, 143.8, 142.3, 140.0, 129.2, 128.4, 127.5, 115.4, 110.7, 48.5, 47.5, 28.3, 24.6, 23.6, 23.6, 22.1.

HRMS (EI) for C₂₅H₃₃NO (M⁺): calc.: 363.2562, found: 363.2564.

### (Process 2) Preparation of Compounds 2a to 2c

Under a nitrogen atmosphere, 3-ethenyl-4-(1-methylethoxy) phenol (1.00 eq.), dibromoalkane (2.00 eq.), cesium carbonate (Cs₂CO₃, 3.0 eq.), and potassium iodide (KI, 0.01 eq.) were placed in a round-bottom flask, and dry acetonitrile was added to obtain a reaction mixture. The reaction mixture was then stirred in the dark at 70° C. for 24 hours. The reaction mixture was cooled to room temperature, the acetonitrile solution was obtained by filtration, and the solvent was concentrated in a vacuum to obtain a product. The product was subjected to an extraction process using dichloromethane (DCM). After removing the DCM in a vacuum, the product was purified by fresh column chromatography eluting with DCM/hexane (2:8), to obtain light-yellow oily Compounds 2a, 2b, and 2c.

Compound 2a (n=6, 526 mg, 51%)

¹H NMR (500 MHz, CDCl₃): δ (ppm) 7.06-7.01 (m, 2H), 6.83 (d, J=8.8 Hz, 1H), 6.75 (d, J=8.6 Hz, 1H), 5.71 (d, J=17.8 Hz, 1H), 5.24 (d, J=11.1 Hz, 1H), 4.37 (quint, J=6.0 Hz, 1H), 3.93 (t, J=6.2 Hz, 2H), 3.43 (t, J=6.7 Hz, 2H), 1.91-1.77 (m, 4H), 1.53-1.48 (m, 4H), 1.31 (d, J=6.0 Hz, 6H).

¹³C NMR (125 MHz, CDCl₃): δ (ppm) 153.5, 149.6, 132.0, 129.5, 117.2, 114.9, 114.2, 112.1, 72.5, 68.4, 33.9, 32.8, 29.4, 28.1, 25.5, 22.4.

HRMS (EI) for C₁₇H₂₅BrO₂ (M⁺): calc.: 340.1038, found: 340.1036.

Compound 2b (n=8, 1.07 g, 74%)

¹H NMR (500 MHz, CDCl₃): δ (ppm) 7.06-7.00 (m, 2H), 6.82 (d, J=8.8 Hz, 1H), 6.75 (dd, J=8.8, 3.0 Hz, 1H), 5.70 (d, J=17.6 Hz, 1H), 5.23 (d, J=11.1 Hz, 1H), 4.37 (quint, J=6.1 Hz, 1H), 3.92 (t, J=6.4 Hz, 2H), 3.41 (t, J=6.8 Hz, 2H), 1.89-1.73 (m, 4H), 1.47-1.36 (m, 8H), 1.31 (d, J=6.0 Hz, 6H).

¹³C NMR (125 MHz, CDCl₃): δ (ppm) 153.6, 149.5, 132.0, 129.5, 117.2, 114.9, 114.2, 112.1, 72.5, 68.6, 34.1, 32.9, 29.5, 29.3, 28.8, 28.3, 26.1, 22.4.

HRMS (EI) for C₁₉H₂₉BrO₂ (M⁺): calc.: 368.1351, found: 368.1352.

Compound 2c (n=10, 2.90 g, 65%)

¹H NMR (500 MHz, CDCl₃): δ (ppm) 7.06-7.01 (m, 2H), 6.82 (d, J=8.8 Hz, 1H), 6.75 (dd, J=8.9, 3.0 Hz, 1H), 5.70 (d, J=17.7, 1.2 Hz, 1H), 5.23 (d, J=11.1, 1.2 Hz, 1H), 4.37 (quint, J=6.1 Hz, 1H), 3.92 (t, J=6.5 Hz, 2H), 3.41 (t, J=6.9 Hz, 2H), 1.88-1.73 (m, 4H), 1.48-1.40 (m, 4H), 1.34-1.30 (m, 14H).

¹³C NMR (125 MHz, CDCl₃): δ (ppm) 153.7, 149.5, 132.1, 129.5, 117.2, 114.9, 114.2, 112.1, 72.5, 68.6, 34.2, 33.0, 29.6, 29.6, 29.5, 28.9, 28.3, 26.2, 22.4. HRMS (FAB) for C₂₁H₃₃BrO₂ (M⁺): calc.: 396.1664, found: 396.1661.

### (Process 3) Preparation of Compounds 3a to 3g

Under a nitrogen atmosphere, Compound 1a, Compound 1b, or Compound 1c (1.10 eq.); Compound 2a, Compound 2b, or Compound 2c (1.00 eq.); cesium carbonate (Cs₂CO₃, 2.0 eq.); and potassium iodide (KI, 0.01 eq.) were placed in a round-bottom flask, and dry acetonitrile was added to obtain a reaction mixture. The reaction mixture was then stirred in the dark at 70° C. for 24 hours. The reaction mixture was cooled to room temperature, the acetonitrile solution was obtained by filtration, and the solvent was concentrated in a vacuum to obtain a product. The product was extracted with DCM. After removing DCM in a vacuum, a product extracted with pentane was obtained. The pentane solution was obtained by filtration through Celite, and the solvent was concentrated in a vacuum to obtain brown oily compounds (3a, 3b, 3c, 3d, 3e, 3f, and 3g) to be used in the next step without further purification.

### (Process 4) Preparation of Compounds 4a to 4g

Under a nitrogen atmosphere, Compound 3a, Compound 3b, Compound 3c, Compound 3d, Compound 3e, Compound 3f, or Compound 3g (1.00 eq.) was placed in a round-bottom flask, and dry hydrochloric acid (2 M in ethanol, 1.10 eq.) was added at 0° C. to obtain a reaction mixture. The reaction mixture was then stirred at room temperature for 30 minutes. Residual hydrochloric acid was removed in a vacuum until bubbling ceased, and the reaction mixture was stirred at 70° C. for 24 hours. The reaction mixture was cooled to room temperature, the acetonitrile solution was obtained by filtration, and the solvent was concentrated in a vacuum to obtain a product. The product was redissolved in DCM, and an aqueous solution of sodium tetrafluoroborate (NaBF₄) was added and stirred for 2 hours to obtain the product. The product was subjected to an extraction process using dichloromethane, followed by washing with distilled water and brine, and then drying with anhydrous sodium sulfate (Na₂SO₄). The dichloromethane solution was removed in a vacuum, and the product was washed with ethanol and pentane and dried in a vacuum to obtain brown jelly-like solid compounds (4a, 4b, 4c, 4d, 4e, 4f, and 4g).

Compound 4a (n=6, R₁₁=Me, R₁₂=H, 784 mg, 78%)

¹H NMR (500 MHz, CD₃CN): δ (ppm) 9.22 (s, 1H), 7.53-7.41 (m, 5H), 7.05-6.98 (m, 2H), 6.89 (d, J=8.9 Hz, 1H), 6.84 (dd, J=16.1, 2.4 Hz, 1H), 6.79 (dd, J=8.9, 3.1 Hz, 1H), 5.76 (dd, J=17.8, 1.3 Hz, 1H), 5.23 (dd, J=11.2, 1.3 Hz, 1H), 4.43 (quint, J=6.1 Hz, 1H), 4.02 (t, J=6.5 Hz, 2H), 3.96 (t, J=6.5 Hz, 2H), 3.00 (d, J=14.0 Hz, 1H), 2.74 (d, J=14.0 Hz, 1H), 2.29 (s, 3H), 2.14 (s, 3H), 1.92 (s, 3H), 1.81-1.75 (m, 4H), 1.59 (s, 3H), 1.54-1.51 (m, 4H), 1.42 (s, 3H), 1.26 (d, J=6.0 Hz, 6H).

¹³C NMR (125 MHz, CD₃CN): δ (ppm) 190.4, 161.0, 154.4, 150.2, 142.1, 136.7, 132.7, 130.7, 129.8, 129.5, 126.9, 126.6, 117.9, 116.2, 116.0, 114.8, 112.5, 85.6, 72.8, 69.2, 69.1, 55.9, 49.5, 29.9, 29.6, 28.4, 28.0, 27.7, 26.4, 26.3, 22.4, 20.1, 19.9.

¹⁹F NMR (470 MHz, CD₃CN): δ (ppm) −151.8, −151.9.

HRMS (FAB) for C₃₈H₅₀NO₃ (M⁺): calc.: 568.3791, found: 568.3788.

Compound 4b (n=8, R₁₁=Me, R₁₂=H, 1.10 g, 64%)

¹H NMR (500 MHz, CD₃CN): δ (ppm) 9.04 (s, 1H), 7.53-7.42 (m, 5H), 7.04-6.97 (m, 2H), 6.89 (d, J=8.9 Hz, 1H), 6.84 (d, J=13.7 Hz, 2H), 6.78 (dd, J=8.9, 2.7 Hz, 1H), 5.76 (d, J=17.8 Hz, 1H), 5.23 (d, J=11.2 Hz, 1H), 4.42 (quint, J=6.0 Hz, 1H), 4.01 (t, J=6.5 Hz, 2H), 3.94 (t, J=6.5 Hz, 2H), 3.00 (d, J=14.1 Hz, 1H), 2.75 (d, J=14.1 Hz, 1H), 2.29 (s, 3H), 2.14 (s, 3H), 1.92 (s, 3H), 1.80-1.71 (m, 4H), 1.59 (s, 3H), 1.46-1.40 (m, 11H), 1.26 (d, J=6.1 Hz, 6H).

¹³C NMR (125 MHz, CD₃CN): δ (ppm) 190.2, 161.1, 154.4, 150.2, 142.0, 136.7, 136.6, 132.7, 130.7, 129.8, 129.5, 126.9, 117.9, 116.2, 116.0, 114.8, 112.5, 85.7, 72.8, 69.3, 69.2, 55.9, 49.5, 30.0, 29.9, 29.9, 29.7, 28.3, 28.0, 27.7, 26.6, 26.5, 22.4, 20.1, 19.9.

¹⁹F NMR (470 MHz, CD₃CN): δ (ppm) −151.8, −151.9.

HRMS (FAB) for C₄₀H₅₄NO₃ (M⁺): calc.: 596.4104, found: 596.4107.

Compound 4c (n=10, R₁₁=Me, R₁₂=H, 3.93 g, 88%)

¹H NMR (500 MHz, CD₃CN): δ (ppm) 9.11 (s, 1H), 7.53-7.41 (m, 5H), 7.04-6.97 (m, 2H), 6.89 (d, J=8.9 Hz, 1H), 6.84 (dd, J=15.9, 2.4 Hz, 2H), 6.78 (dd, J=8.9, 3.0 Hz, 1H), 5.75 (dd, J=17.8, 1.3 Hz, 1H), 5.23 (dd, J=11.2, 1.3 Hz, 1H), 4.42 (quint, J=6.0 Hz, 1H), 4.00 (t, J=6.5 Hz, 2H), 3.94 (t, J=6.5 Hz, 2H), 3.00 (d, J=14.1 Hz, 1H), 2.75 (d, J=14.1 Hz, 1H), 2.29 (s, 3H), 2.14 (s, 3H), 1.92 (s, 3H), 1.79-1.69 (m, 4H), 1.59 (s, 3H), 1.46-1.43 (m, 7H), 1.40-1.32 (m, 8H), 1.26 (d, J=6.1 Hz, 6H).

¹³C NMR (125 MHz, CD₃CN): δ (ppm) 190.3, 161.1, 154.4, 150.2, 142.0, 136.6, 132.7, 130.7, 129.8, 129.5, 126.9, 126.6, 117.9, 116.2, 116.0, 114.8, 112.6, 85.6, 72.9, 69.3, 69.2, 55.9, 49.5, 30.1, 30.1, 30.0, 30.0, 29.9, 29.7, 28.3, 28.0, 27.7, 26.7, 26.6, 22.4, 20.1, 19.9.

¹⁹F NMR (470 MHz, CD₃CN): δ (ppm) −151.8, −151.8.

HRMS (FAB) for C₄₂H₅₈NO₃ (M⁺): calc.: 624.4417, found: 624.4419.

Compound 4d (n=6, R₁₁=Et, R₁₂=H, 1.15 g, 77%)

¹H NMR (500 MHz, CD₃CN): δ (ppm) 9.25 (s, 1H), 7.54-7.51 (m, 2H), 7.46-7.42 (m, 3H), 7.05-6.98 (m, 1H), 6.93-6.89 (m, 2H), 6.79 (dd, J=8.9, 3.1 Hz, 1H), 5.76 (d, J=17.8 Hz, 1H), 5.23 (d, J=11.2 Hz, 1H), 4.43 (quint, J=6.1 Hz, 1H), 4.06 (t, J=6.5 Hz, 2H), 3.96 (t, J=6.5 Hz, 2H), 3.03 (d, J=14.1 Hz, 1H), 2.75 (d, J=14.1 Hz, 1H), 2.63 (dt, J=7.5 Hz, 1H), 2.51-2.43 (m, 2H), 2.28 (dt, J=7.4 Hz, 1H), 1.92 (s, 3H), 1.83-1.75 (m, 4H), 1.55-1.52 (m, 7H), 1.36 (s, 3H), 1.27-1.23 (m, 9H), 1.14 (t, J=7.5 Hz, 3H).

¹³C NMR (125 MHz, CD₃CN): δ (ppm) 190.7, 161.8, 154.5, 150.3, 142.7, 142.5, 142.3, 132.8, 130.7, 129.9, 129.5, 126.9, 124.5, 118.0, 116.1, 114.8, 114.5, 114.5, 112.7, 85.1, 72.9, 69.2, 56.0, 49.2, 30.0, 29.7, 28.5, 27.5, 27.4, 26.5, 26.4, 26.1, 25.9, 22.4, 15.8, 15.6.

¹⁹F NMR (470 MHz, CD₃CN): δ (ppm) −151.6, −151.6.

HRMS (FAB) for C₄₀H₅₄NO₃ (M⁺): calc.: 596.4104, found: 596.4102.

Compound 4e (n=6, R₁₁=ⁱPr, R₁₂=H, 1.63 g, 84%)

¹H NMR (500 MHz, CD₃CN): δ (ppm) 9.18 (s, 1H), 7.53 (t, J=7.5 Hz, 2H), 7.46-7.42 (m, 3H), 7.05-6.98 (m, 2H), 6.95-6.88 (m, 3H), 6.79 (dd, J=8.9, 2.9 Hz, 1H), 5.76 (d, J=17.8 Hz, 1H), 5.23 (d, J=11.2 Hz, 1H), 4.43 (quint, J=6.1 Hz, 1H), 4.08 (t, J=6.5 Hz, 1H), 3.96 (t, J=6.4 Hz, 2H), 3.06 (d, J=14.1 Hz, 1H), 2.80-2.72 (m, 2H), 2.51 (quint, J=6.7 Hz, 1H), 1.91 (s, 3H), 1.83-1.76 (m, 4H), 1.56-1.54 (m, 7H), 1.37-1.36 (m, 6H), 1.26 (d, J=6.0 Hz, 6H), 1.23 (d, J=6.7 Hz, 3H), 1.15 (d, J=6.7 Hz, 3H), 1.08 (d, J=6.6 Hz, 3H).

¹³C NMR (125 MHz, CD₃CN): δ (ppm) 190.0, 162.5, 154.5, 150.3, 147.6, 147.3, 142.1, 132.8, 130.8, 129.9, 129.6, 126.7, 122.7, 118.0, 116.1, 114.8, 112.7, 112.3, 112.2, 85.2, 72.9, 69.3, 69.2, 55.9, 49.1, 30.7, 30.5, 30.0, 29.8, 27.8, 27.5, 27.4, 26.5, 26.4, 26.1, 26.0, 22.4, 22.1, 22.0.

¹⁹F NMR (470 MHz, CD₃CN): δ (ppm) −151.7, −151.7.

HRMS (FAB) for C₄₂H₅₈NO₃ (M⁺): calc.: 624.4417, found: 624.4414.

Compound 4f (n=6, R₁₁=Et, R₁₂=Ph, 1.56 g, 75%)

¹H NMR (500 MHz, CD₃CN): δ (ppm) 9.12 (s, 1H), 7.56-7.51 (m, 4H), 7.45-7.41 (m, 5H), 7.37-7.34 (m, 1H), 7.14-7.08 (m, 2H), 6.90 (dd, J=16.9, 2.7 Hz, 2H), 6.83 (d, J=3.1 Hz, 1H), 5.81 (d, J=17.8 Hz, 1H), 5.30 (d, J=11.1 Hz, 1H), 4.07-4.02 (m, 4H), 3.61 (quint, J=6.2 Hz, 1H), 3.03 (d, J=14.1 Hz, 1H), 2.75 (d, J=14.1 Hz, 1H), 2.63 (dt, J=7.5 Hz, 1H), 2.50-2.43 (m, 2H), 2.27 (dt, J=7.5 Hz, 1H), 1.91 (s, 3H), 1.84-1.77 (m, 4H), 1.56-1.53 (m, 7H), 1.36 (s, 3H), 1.23 (t, J=6.9 Hz, 3H), 1.13 (t, J=6.9 Hz, 3H), 0.90 (d, J=6.2 Hz, 6H).

¹³C NMR (125 MHz, CD₃CN): δ (ppm) 190.0, 161.8, 156.1, 147.3, 142.7, 142.5, 142.1, 140.2, 137.8, 134.2, 133.5, 130.8, 130.1, 129.6, 129.1, 128.2, 126.8, 124.5, 117.8, 115.3, 114.5, 114.5, 110.9, 85.3, 76.5, 69.3, 69.2, 55.9, 49.3, 30.0, 29.7, 28.1, 27.5, 27.5, 26.5, 26.4, 26.0, 25.9, 22.1, 15.7, 15.6.

¹⁹F NMR (470 MHz, CD₃CN): δ (ppm) −151.8, −151.9.

HRMS (FAB) for C₄₆H₅₈NO₃ (M⁺): calc.: 672.4417, found: 672.4414.

Compound 4g (n=6, R₁₁=ⁱPr, R₁₂=Ph, 1.97 g, 87%)

¹H NMR (500 MHz, CD₃CN): δ (ppm) 9.18 (s, 1H), 7.56-7.52 (m, 4H), 7.46-7.41 (m, 5H), 7.37-7.34 (m, 1H), 7.14-7.08 (m, 2H), 6.92 (dd, J=19.4, 2.7 Hz, 2H), 6.83 (d, J=3.1 Hz, 1H), 5.80 (d, J=17.7 Hz, 1H), 5.30 (d, J=11.1 Hz, 1H), 4.08 (t, J=6.5 Hz, 2H), 4.04 (t, J=6.5 Hz, 2H), 3.61 (quint, J=6.2 Hz, 1H), 3.06 (d, J=14.1 Hz, 1H), 2.79-2.71 (m, 2H), 2.51 (quint, J=6.7 Hz, 1H), 1.91 (s, 3H), 1.83-1.79 (m, 4H), 1.56-1.54 (m, 7H), 1.37-1.35 (m, 6H), 1.22 (d, J=6.7 Hz, 6H), 1.14 (d, J=6.7 Hz, 6H), 1.07 (d, J=6.7 Hz, 6H), 0.90 (d, J=6.2 Hz, 6H).

¹³C NMR (125 MHz, CD₃CN): δ (ppm) 190.0, 162.5, 156.1, 147.6, 147.4, 147.3, 142.1, 140.2, 137.8, 134.2, 133.5, 130.8, 130.2, 129.6, 129.1, 128.2, 126.7, 122.7, 117.8, 115.3, 112.3, 112.2, 110.9, 85.2, 76.5, 69.3, 69.2, 55.9, 49.1, 30.7, 30.5, 30.0, 29.8, 27.8, 27.5, 27.4, 26.5, 26.4, 26.1, 26.0, 22.1, 22.0.

¹⁹F NMR (470 MHz, CD₃CN): δ (ppm) −151.7, −151.7.

HRMS (FAB) for C₄₈H₆₂NO₃ (M⁺): calc.: 700.4730, found: 700.4731.

### (Process 5) Preparation of Compounds Ru-1 to Ru-7

Under a nitrogen atmosphere, Compound 4a, Compound 4b, Compound 4c, Compound 4d, Compound 4e, Compound 4f, or Compound 4g (2.00 eq.) was placed in a round-bottom flask, dry toluene was added, and lithium bis(trimethylsilyl)amide (LiHMDS, 1 M in toluene, 2.10 eq.) was added at room temperature to obtain a reaction mixture. The reaction mixture was stirred at room temperature for 30 minutes. To the stirred reaction mixture, a dry toluene solution of the ruthenium precursor (1st generation Grubbs complex) was slowly added. The reaction mixture including the ruthenium precursor was stirred overnight at 40° C., and then stirred again overnight at 70° C. The toluene was then removed under vacuum, and the resulting reaction product was purified by fresh column chromatography eluting with ethyl acetate (EtOAc)/hexane (2:8), to obtain a solid. The solid was diluted in a small amount of DCM and precipitated in pentane to obtain dark green solid compounds (Ru-1 to Ru-7).

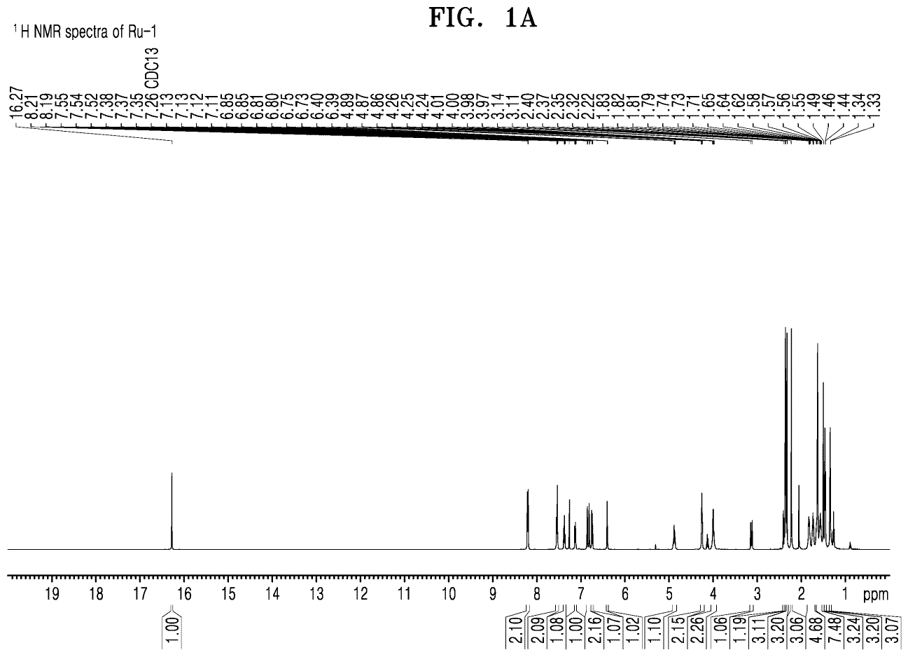

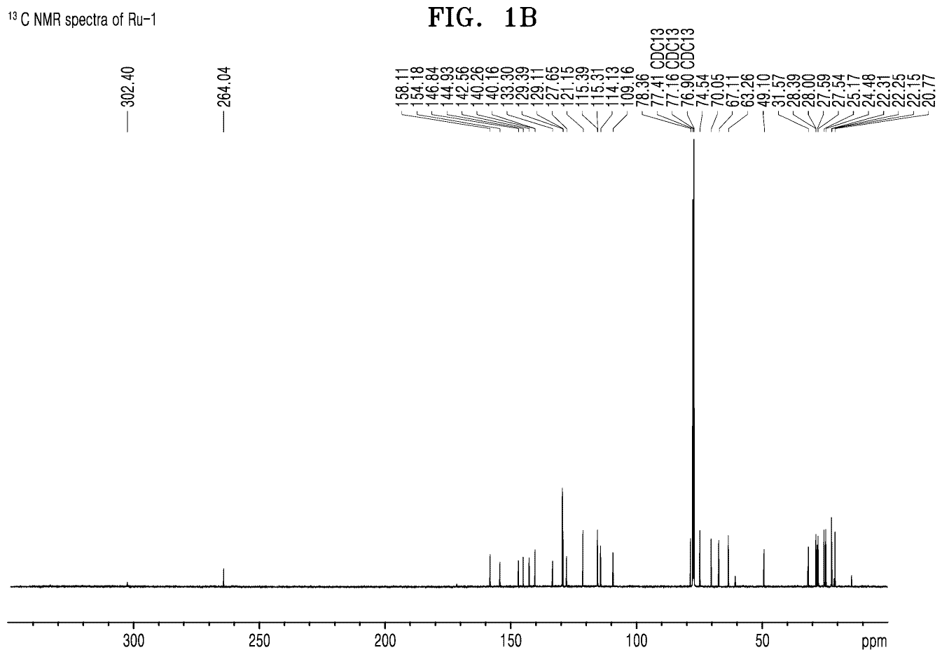

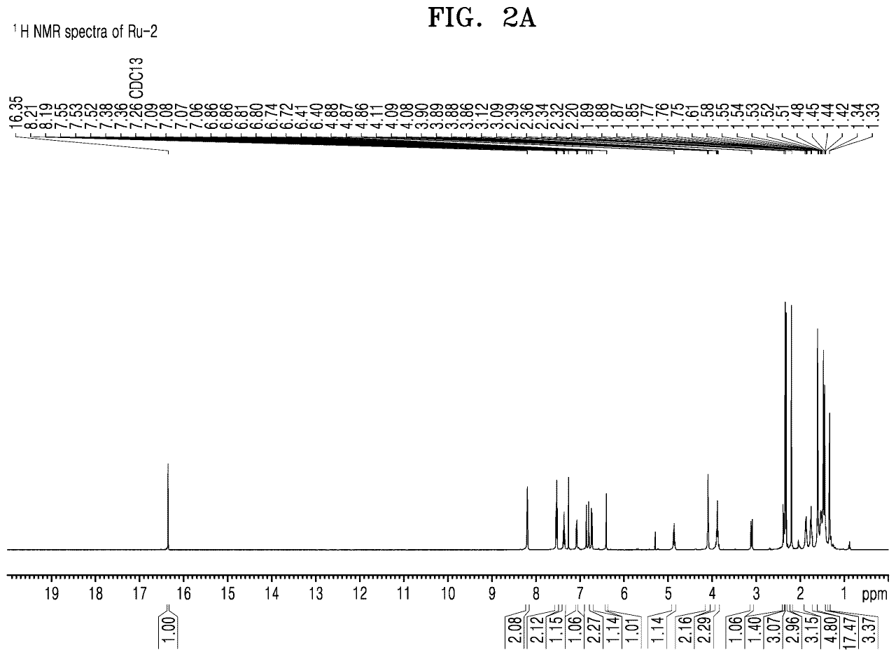

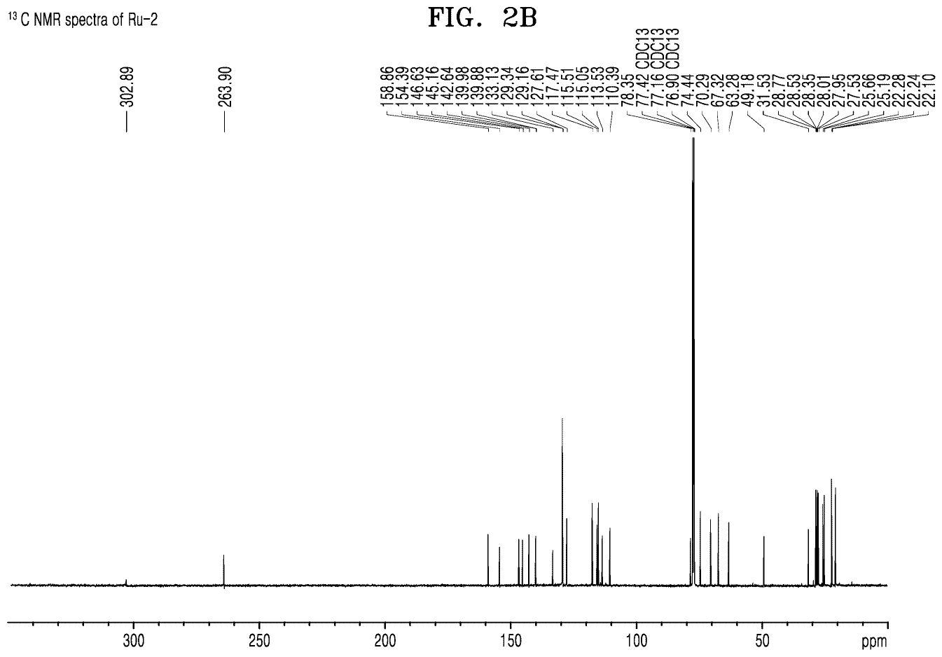

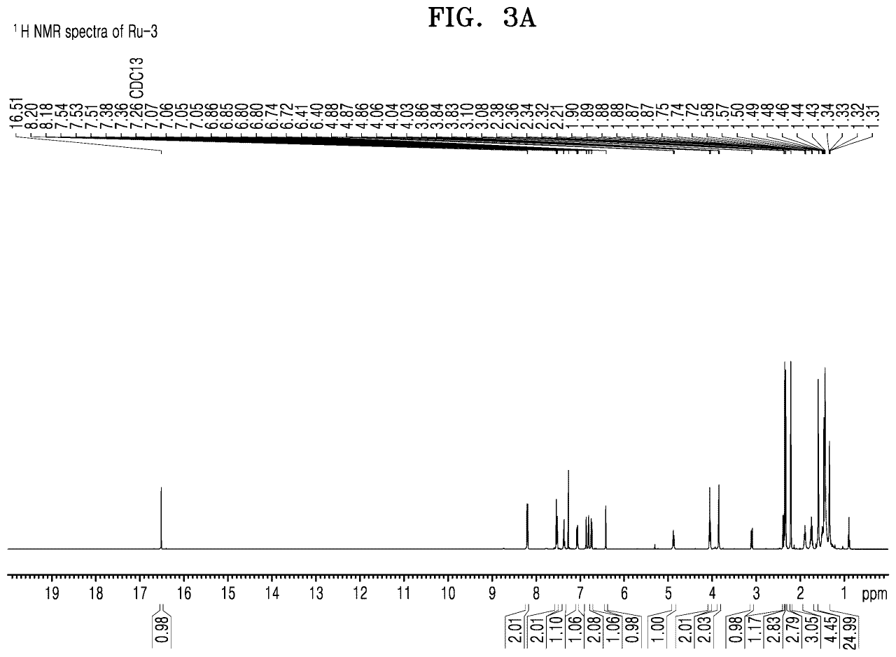

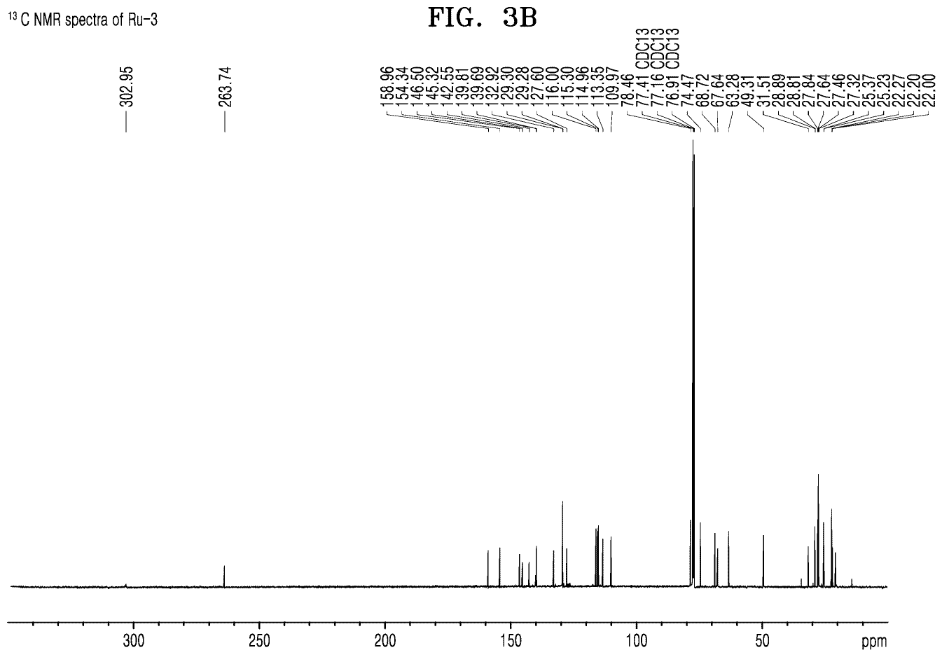

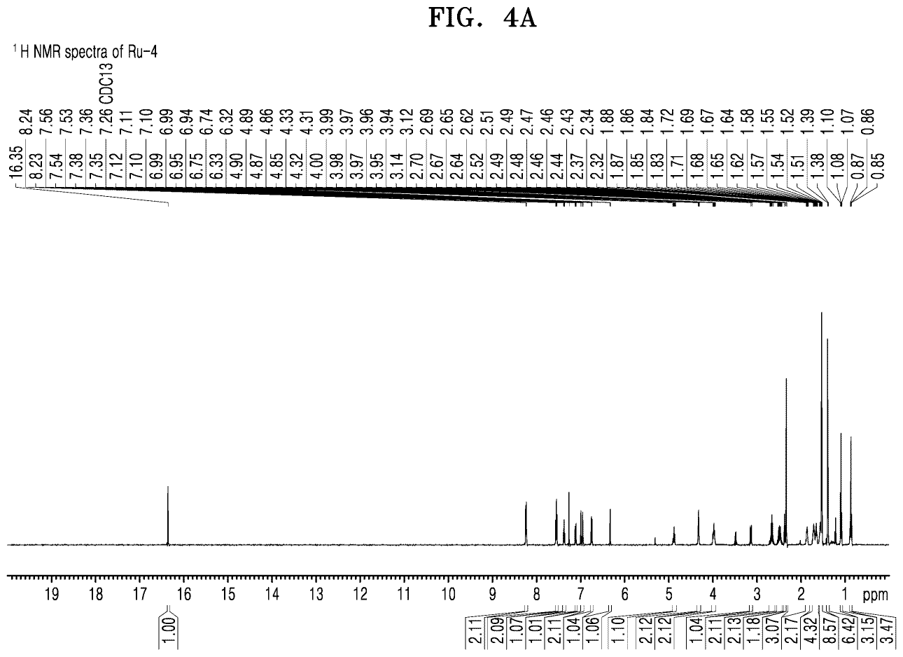

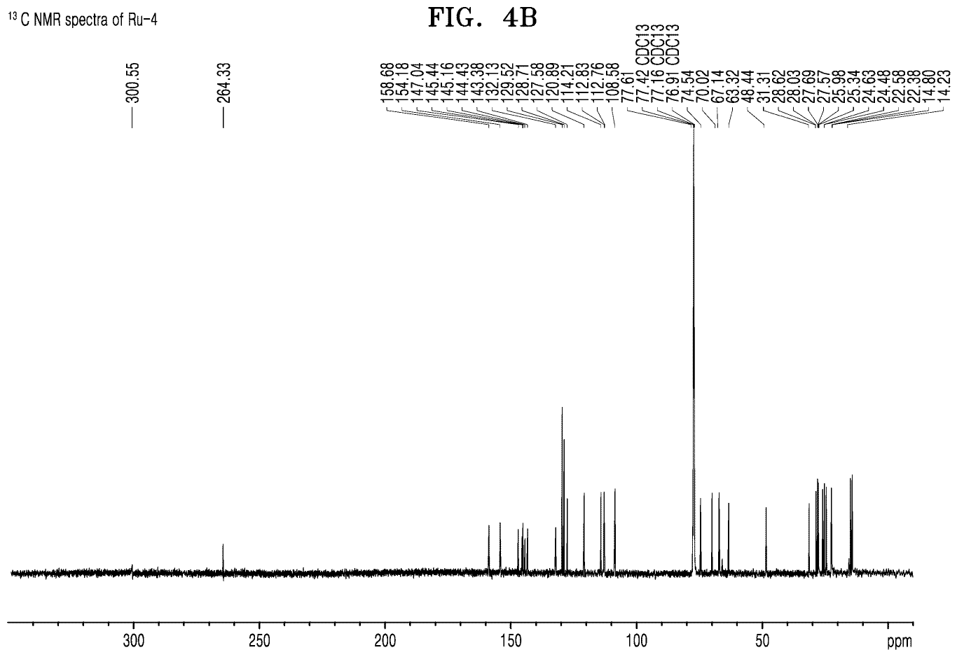

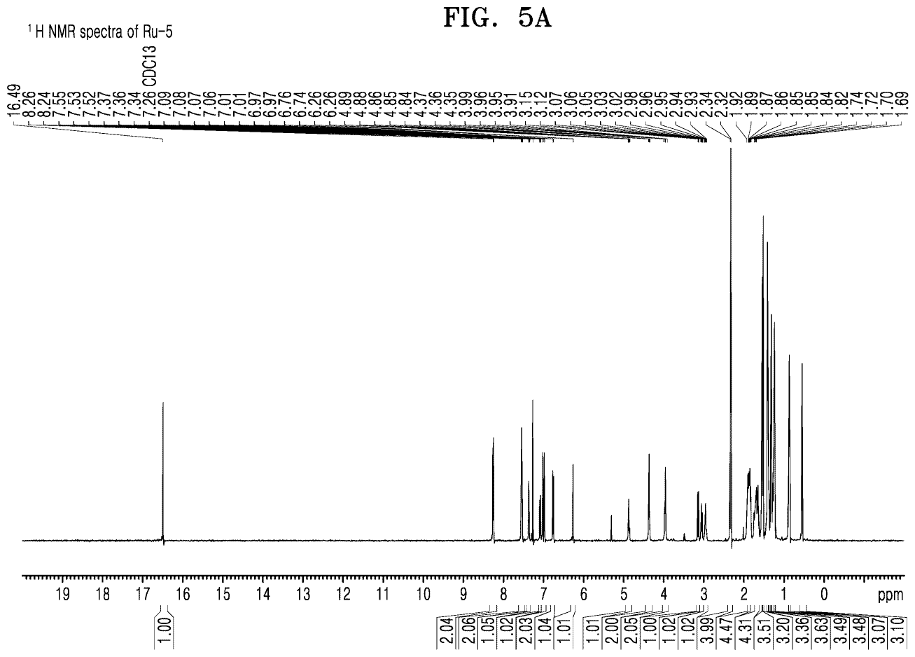

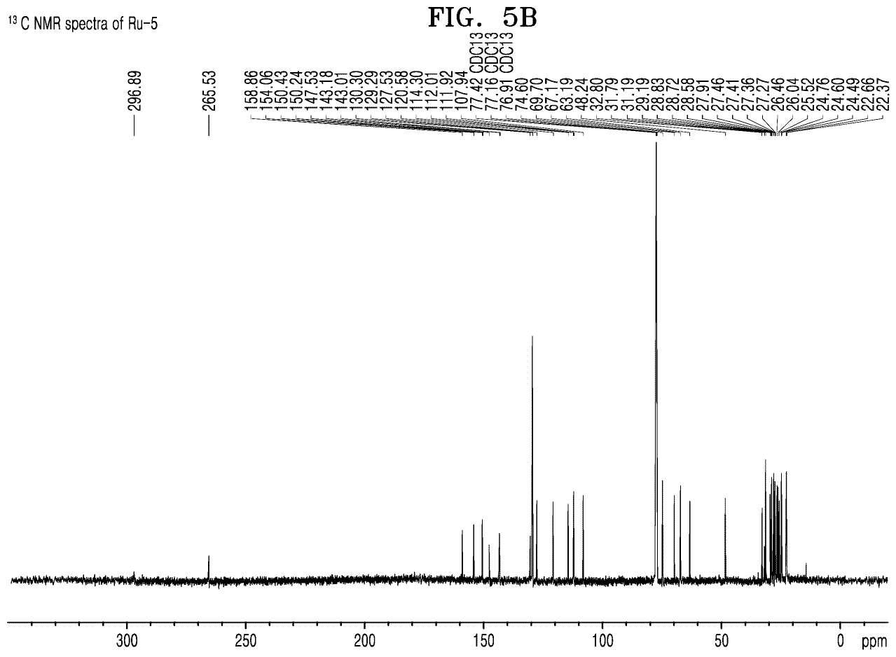

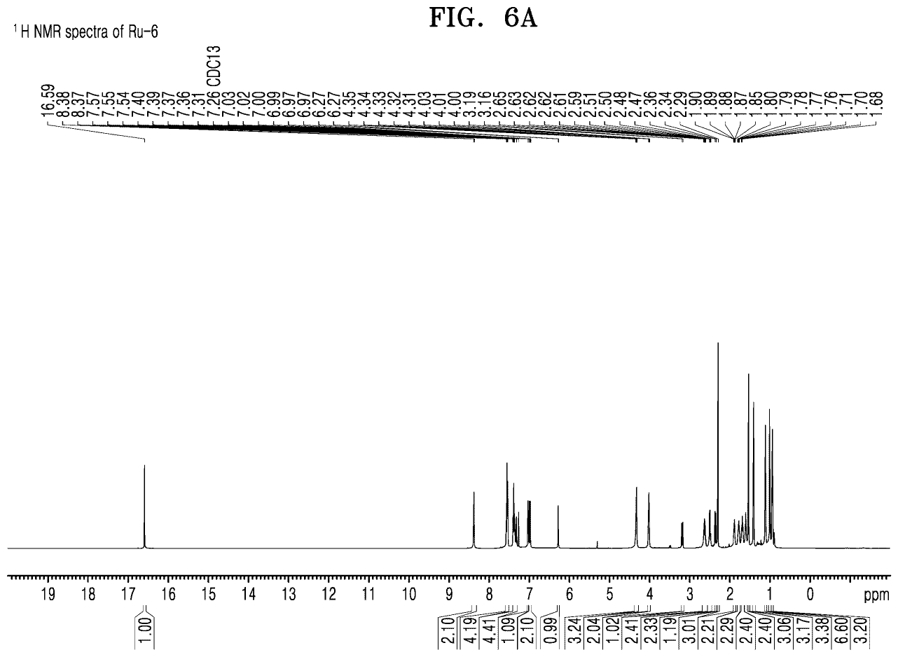

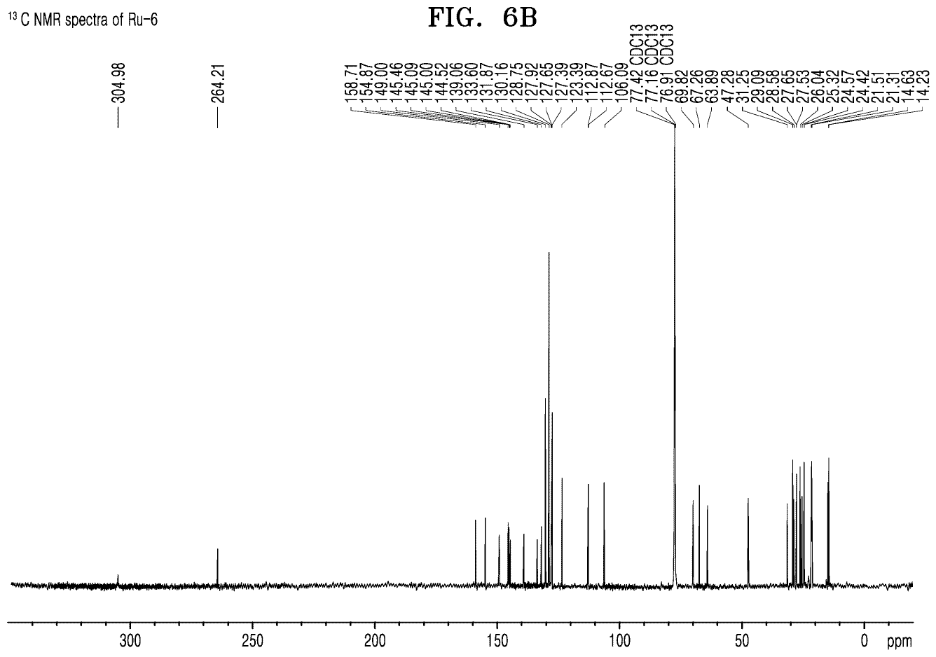

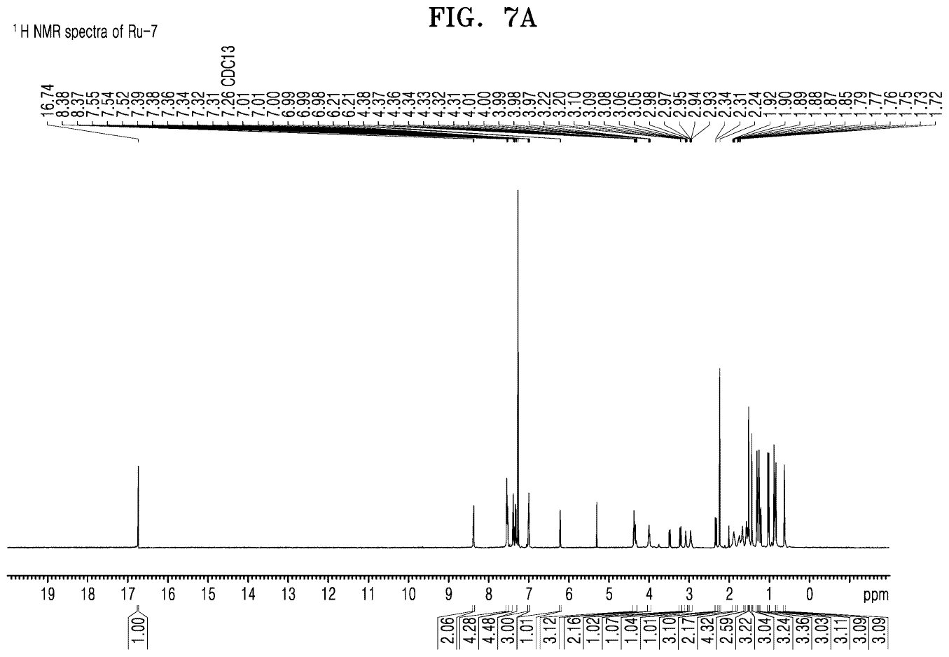

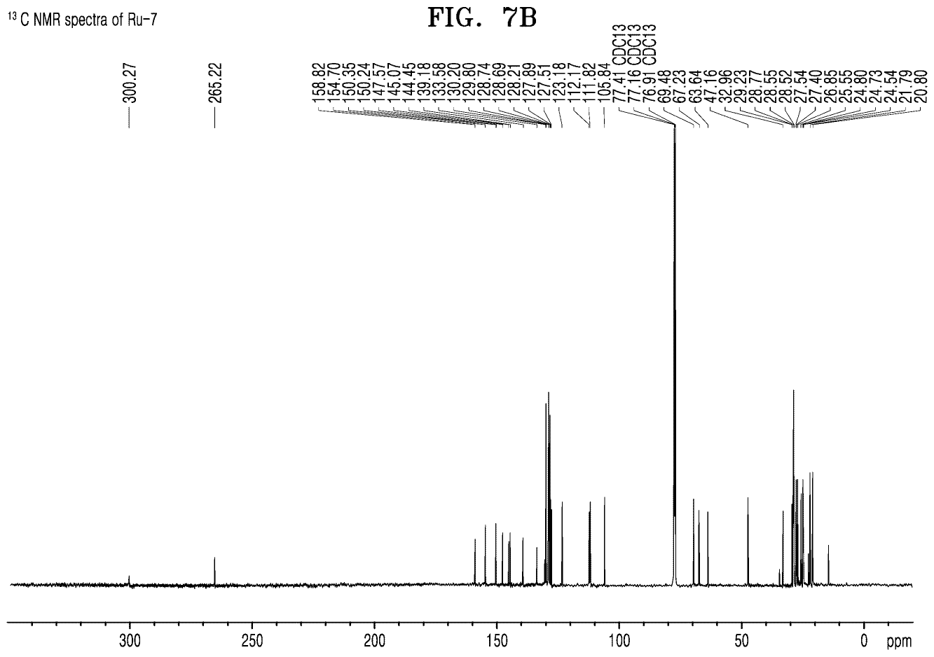

The ¹H NMR spectrum and ¹³C NMR spectrum of Compound Ru-1 are shown in FIG. 1A and FIG. 1B. The ¹H NMR spectrum and ¹³C NMR spectrum of Compound Ru-2 are shown in FIG. 2A and FIG. 2B. The ¹H NMR spectrum and ¹³C NMR spectrum of Compound Ru-3 are shown in FIG. 3A and FIG. 3B. The ¹H NMR spectrum and ¹³C NMR spectrum of Compound Ru-4 are shown in FIG. 4A and FIG. 4B. The ¹H NMR spectrum and ¹³C NMR spectrum of Compound Ru-5 are shown in FIG. 5A and FIG. 5B. The 1H NMR spectrum and ¹³C NMR spectrum of Compound Ru-6 are shown in FIG. 6A and FIG. 6B. The ¹H NMR spectrum and ¹³C NMR spectrum of Compound Ru-7 are shown in FIG. 7A and FIG. 7B.

Compound Ru-1 (n−1=5, R₁₁=Me, R₁₂=H, 38 mg, 18%)

¹H NMR (500 MHz, CDCl₃): δ (ppm) 16.27 (s, 1H), 8.20 (d, J=7.5 Hz, 2H), 7.54 (t, J=7.8 Hz, 2H), 7.37 (t, J=7.4 Hz, 1H), 7.12 (dd, J=8.9, 2.9 Hz, 1H), 6.83 (dd, J=23.5, 2.5 Hz, 2H), 6.74 (d, J=9.0 Hz, 1H), 6.39 (d, J=2.9 Hz, 1H), 4.87 (quint, J=6.2 Hz, 1H), 4.25 (t, J=5.1 Hz, 2H), 3.99 (m, 2H), 3.12 (d, J=12.8 Hz, 1H), 2.38 (d, J=12.8 Hz, 1H), 2.35 (s, 3H), 2.32 (s, 3H), 2.22 (s, 3H), 1.82-1.70 (m, 4H), 1.65-1.55 (m, 7H), 1.49 (s, 3H), 1.45 (d, J=6.1 Hz, 3H), 1.34 (d, J=6.1 Hz, 3H).

¹³C NMR (125 MHz, CDCl₃): δ (ppm) 302.4, 264.0, 158.1, 154.2, 146.8, 144.9, 142.6, 140.3, 140.2, 133.3, 129.4, 129.1, 127.7, 121.2, 115.4, 115.3, 114.1, 109.2, 78.4, 74.5, 70.0, 67.1, 63.3, 49.1, 31.6, 28.4, 28.0, 27.6, 27.5, 25.2, 24.5, 22.3, 22.3, 22.1, 20.8. HRMS (EI) for C₃₇H₄₇C₁₂NO₃Ru (M⁺): calc.: 725.1976, found: 725.1978.

Compound Ru-2 (n−1=7, R₁₁=Me, R₁₂=H, 49 mg, 15%)

¹H NMR (500 MHz, CDCl₃): δ (ppm) 16.35 (s, 1H), 8.20 (d, J=7.5 Hz, 2H), 7.53 (t, J=7.8 Hz, 2H), 7.36 (t, J=7.4 Hz, 1H), 7.08 (dd, J=8.9, 2.9 Hz, 1H), 6.83 (dd, J=28.7, 2.7 Hz, 2H), 6.73 (d, J=9.0 Hz, 1H), 6.41 (d, J=2.9 Hz, 1H), 4.87 (quint, J=6.2 Hz, 1H), 4.09 (t, J=5.9 Hz, 2H), 3.88 (m, 2H), 3.11 (d, J=12.8 Hz, 1H), 2.38 (d, J=12.8 Hz, 1H), 2.34 (s, 3H), 2.32 (s, 3H), 2.20 (s, 3H), 1.92-1.73 (m, 4H), 1.62-1.42 (m, 17H), 1.34 (d, J=6.1 Hz, 3H).

¹³C NMR (125 MHz, CDCl₃): δ (ppm) 302.9, 263.9, 158.9, 154.4, 146.6, 145.2, 142.6, 140.0, 139.9, 133.1, 129.3, 129.2, 127.6, 117.5, 115.5, 115.1, 113.5, 110.4, 78.4, 74.4, 70.3, 67.3, 63.3, 49.2, 31.5, 28.8, 28.5, 28.3, 28.0, 28.0, 27.5, 25.7, 25.2, 22.3, 22.2, 22.1, 20.7.

HRMS (EI) for C₃₉H₅₁C₁₂NO₃Ru (M⁺): calc.: 753.2289, found: 753.2286.

Compound Ru-3 (n−1=9, R₁₁=Me, R₁₂=H, 27 mg, 8%)

¹H NMR (500 MHz, CDCl₃): δ (ppm) 16.51 (s, 1H), 8.19 (d, J=7.4 Hz, 2H), 7.53 (t, J=7.9 Hz, 2H), 7.36 (t, J=7.4 Hz, 1H), 7.06 (dd, J=9.0, 3.0 Hz, 1H), 6.83 (dd, J=27.5, 2.8 Hz, 2H), 6.73 (d, J=8.9 Hz, 1H), 6.41 (d, J=3.0 Hz, 1H), 4.87 (quint, J=6.1 Hz, 1H), 4.04 (t, J=6.4 Hz, 2H), 3.84 (t, J=6.1 Hz, 2H), 3.09 (d, J=12.8 Hz, 1H), 2.37 (d, J=12.8 Hz, 1H), 2.34 (s, 3H), 2.32 (s, 3H), 2.21 (s, 3H), 1.92-1.70 (m, 4H), 1.60-1.28 (m, 24H).

¹³C NMR (125 MHz, CDCl₃): δ (ppm) 303.0, 263.7, 159.0, 154.3, 146.5, 145.3, 142.6, 139.8, 139.7, 132.9, 129.3, 129.3, 127.6, 116.0, 115.3, 115.0, 113.3, 110.0, 78.5, 74.5, 68.7, 67.6, 63.3, 49.3, 31.5, 28.9, 28.8, 27.8, 27.6, 27.5, 27.3, 25.4, 25.2, 22.3, 22.2, 22.0, 20.6.

HRMS (FAB) for C₄₁H₅₅Cl₂NO₃Ru (M⁺): calc.: 781.2602, found: 781.2606.

Compound Ru-4 (n−1=5, R₁₁=Et, R₁₂=H, 19 mg, 9%)

¹H NMR (500 MHz, CDCl₃): δ (ppm) 16.35 (s, 1H), 8.23 (d, J=7.5 Hz, 2H), 7.54 (t, J=7.9 Hz, 2H), 7.36 (t, J=7.4 Hz, 1H), 7.11 (dd, J=8.9, 3.0 Hz, 1H), 6.97 (dd, J=22.2, 2.9 Hz, 2H), 6.75 (d, J=9.0 Hz, 1H), 6.32 (d, J=3.0 Hz, 1H), 4.87 (quint, J=6.2 Hz, 1H), 4.32 (t, J=5.3 Hz, 2H), 4.01-3.93 (m, 2H), 3.13 (d, J=12.6 Hz, 1H), 2.65 (heptet, J=7.8 Hz, 2H), 2.52-2.43 (m, 2H), 2.36 (d, J=12.6 Hz, 1H), 2.32 (s, 3H), 1.88-1.83 (m, 2H), 1.72-1.62 (m, 4H), 1.58-1.51 (m, 8H), 1.39-1.38 (m, 6H), 1.08 (t, J=7.4 Hz, 3H), 0.86 (t, J=7.4 Hz, 3H).

¹³C NMR (125 MHz, CDCl₃): δ (ppm) 300.6, 264.3, 158.7, 154.2, 147.0, 145.4, 145.2, 144.4, 143.4, 132.1, 129.5, 128.7, 127.6, 120.9, 114.2, 112.8, 112.8, 108.6, 77.6, 74.5, 70.0, 67.1, 63.3, 48.4, 31.3, 28.6, 28.0, 27.7, 27.6, 26.0, 25.3, 24.6, 24.5, 22.6, 22.4, 14.8, 14.2.

HRMS (FAB) for C₃₉H₅₁Cl₂NO₃Ru (M⁺): calc.: 753.2289, found: 753.2294.

Compound Ru-5 (n−1=5, R₁₁=ⁱPr, R₁₂=H, 94 mg, 42%)

¹H NMR (500 MHz, CDCl₃): δ (ppm) 16.49 (s, 1H), 8.25 (d, J=7.9 Hz, 2H), 7.53 (t, J=7.8 Hz, 2H), 7.36 (t, J=7.4 Hz, 1H), 7.08 (dd, J=9.0, 2.9 Hz, 1H), 6.99 (dd, J=21.0, 2.9 Hz, 2H), 6.75 (d, J=9.0 Hz, 1H), 6.26 (d, J=2.9 Hz, 1H), 4.86 (quint, J=6.1 Hz, 1H), 4.36 (t, J=5.3 Hz, 2H), 3.99-3.91 (m, 2H), 3.13 (d, J=12.8 Hz, 1H), 3.05 (quint, J=6.5 Hz, 2H), 2.95 (quint, J=6.5 Hz, 2H), 2.34-2.32 (m, 4H), 1.92-1.82 (m, 4H), 1.74-1.61 (m, 4H), 1.54 (d, J=6.1 Hz, 3H), 1.51 (s, 3H), 1.40 (s, 3H), 1.38 (d, J=6.1 Hz, 3H), 1.32 (d, J=6.7 Hz, 3H), 1.23 (d, J=6.6 Hz, 3H), 0.85 (d, J=6.5 Hz, 3H), 0.54 (d, J=6.3 Hz, 3H).

¹³C NMR (125 MHz, CDCl₃): δ (ppm) 296.9, 265.5, 158.9, 154.1, 150.4, 150.2, 147.5, 143.2, 143.0, 130.3, 129.3, 127.5, 120.6, 114.3, 112.0, 111.9, 107.9, 74.6, 69.7, 67.2, 63.2, 48.2, 32.8, 31.8, 31.2, 29.2, 28.8, 28.7, 28.6, 27.9, 27.5, 27.4, 27.4, 27.3, 26.5, 26.0, 25.5, 24.8, 24.6, 24.5, 22.7, 22.4.

HRMS (FAB) for C₄₁H₅₅Cl₂NO₃Ru (M⁺): calc.: 781.2602, found: 781.2604.

Compound Ru-6 (n−1=5, R₁₁=Et, R₁₂=Ph, 31 mg, 13%)

¹H NMR (500 MHz, CDCl₃): δ (ppm) 16.59 (s, 1H), 8.38 (d, J=8.1 Hz, 2H), 7.57-7.54 (m, 4H), 7.40-7.31 (m, 4H), 7.03 (d, J=3.0 Hz, 1H), 6.98 (dd, J=13.5, 2.7 Hz, 2H), 6.27 (d, J=3.0 Hz, 1H), 4.35-4.31 (m, 3H), 4.01 (t, J=7.4 Hz, 2H), 3.18 (d, J=12.5 Hz, 1H), 2.65-2.59 (m, 2H), 2.49 (q, J=7.5 Hz, 2H), 2.35 (d, J=12.5 Hz, 1H), 2.29 (s, 3H), 1.90-1.85 (m, 2H), 1.80-1.76 (m, 2H), 1.71-1.65 (m, 2H), 1.62-1.57 (m, 2H), 1.52 (s, 3H), 1.40 (s, 3H), 1.10 (t, J=7.4 Hz, 3H), 1.00-0.98 (m, 6H), 0.93 (t, J=7.4 Hz, 3H).

¹³C NMR (125 MHz, CDCl₃): δ (ppm) 305.0, 264.2, 158.7, 154.9, 149.0, 145.5, 145.1, 145.0, 144.5, 139.1, 133.6, 131.9, 130.2, 128.8, 127.9, 127.7, 127.4, 123.4, 112.9, 112.7, 106.1, 69.8, 67.3, 63.9, 47.3, 31.3, 29.1, 28.6, 27.6, 27.5, 26.0, 25.3, 24.6, 24.4, 21.5, 21.3, 14.6, 14.2.

HRMS (FAB) for C₄₅H₅₅Cl₂NO₃Ru (M⁺): calc.: 829.2602, found: 829.2602.

Compound Ru-7 (n−1=5, R₁₁=ⁱPr, R₁₂=Ph, 38 mg, 15%)

¹H NMR (500 MHz, CDCl₃): δ (ppm) 16.74 (s, 1H), 8.37 (d, J=7.6 Hz, 2H), 7.55-7.52 (m, 4H), 7.39-7.31 (m, 4H), 7.01-6.98 (m, 3H), 6.21 (d, J=3.0 Hz, 1H), 4.38-4.31 (m, 3H), 4.01-3.97 (m, 2H), 3.21 (d, J=12.6 Hz, 1H), 3.08 (quint, J=6.5 Hz, 1H), 2.95 (quint, J=6.6 Hz, 1H), 2.32 (d, J=12.6 Hz, 1H), 2.24 (s, 3H), 1.92-1.85 (m, 2H), 1.79-1.65 (m, 4H), 1.57-1.53 (m, 2H), 1.51 (s, 3H), 1.43 (s, 3H), 1.30 (d, J=6.6 Hz, 3H), 1.25 (d, J=6.6 Hz, 3H), 1.02 (d, J=6.3 Hz, 3H), 0.87 (d, J=6.3 Hz, 3H), 0.83 (d, J=6.4 Hz, 3H), 0.62 (d, J=6.3 Hz, 3H).

¹³C NMR (125 MHz, CDCl₃): δ (ppm) 300.3, 265.2, 158.8, 154.7, 150.3, 150.2, 147.6, 145.1, 144.4, 139.2, 133.6, 130.2, 129.8, 128.7, 128.7, 128.2, 127.9, 127.5, 123.2, 112.2, 111.8, 105.8, 69.5, 67.2, 63.6, 47.2, 33.0, 29.2, 28.8, 28.5, 28.5, 27.5, 27.4, 26.9, 25.5, 24.8, 24.7, 24.5, 21.8, 20.8.

HRMS (FAB) for C₄₇H₅₉C₁₂NO₃Ru (M⁺): calc.: 857.2915, found: 857.291.

### Reference Example 1: Compound UltraNitroCat-1

The compound represented by Formula A below, 1-(2,6-diethylphenyl)-3,5,5-trimethyl-3-phenylpyrrolidin-2-yl](2-isopropoxy-5-nitrobenzylidene)ruthenium(II) chloride (UltraNitroCat-1), was purchased from Tokyo Chemical Industry Co., Ltd. and used as received.

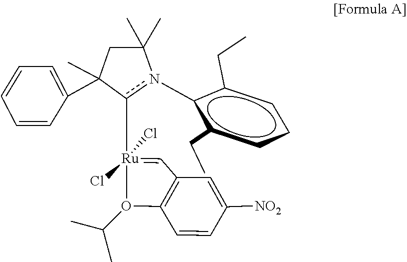

### Analysis Example 1: X-ray Crystallographic Analysis

X-ray crystallographic analysis was performed on Compounds Ru-1 to Ru-7 prepared in Examples 1 to 7. The crystals used for X-ray crystallographic analysis were coated with paratone-N oil. Diffraction data were collected using synchrotron radiation on the 2D and 11C beamlines at the Pohang Accelerator Laboratory in Korea. According to Journal of Applied Crystallography 2009, 42, 339-341, the structures were solved using Olex2 and ShelXT via intrinsic phasing according to Sheldrick, G., Acta Crystallographica Section A 2015, 71, 3-8, and refined using least-squares minimization with ShelXL according to Sheldrick, G., Acta Crystallographica Section C 2015, 71, 3-8. The results are shown in Table 1 below.

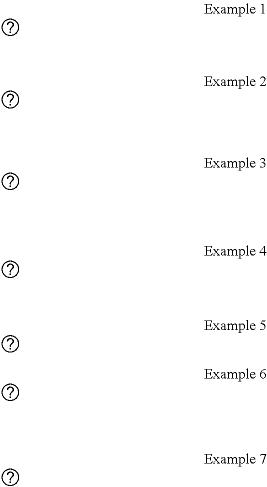

TABLE 1

| | Crystal | Space | Ru—C1 | Ru—C2 | Ru—O | Ru—C11 | Ru—C12 | Cl—Ru—O |
|---|---|---|---|---|---|---|---|---|
| | Structure | Group | (Å) | (Å) | (Å) | (Å) | (Å) | (°) |
| Example 1 | Monoclinic | P2₁/n | 1.952 | 1.860 | 2.329 | 2.333 | 2.348 | 176.4 |
| Example 2 | Triclinic | P-1 | 1.951 | 1.844 | 2.324 | 2.331 | 2.350 | 177.5 |
| Example 3 | Triclinic | P-1 | 1.955 | 1.843 | 2.323 | 2.334 | 2.339 | 177.9 |
| Example 4 | Triclinic | P-1 | 1.935 | 1.849 | 2.320 | 2.332 | 2.348 | 177.7 |
| Example 5 | Monoclinic | P2₁/c | 1.948 | 1.838 | 2.334 | 2.324 | 2.340 | 175.5 |
| Example 6 | Monoclinic | P2₁/c | 1.963 | 1.832 | 2.371 | 2.340 | 2.358 | 176.0 |
| Example 7 | Monoclinic | P2₁/n | 1.981 | 1.846 | 2.338 | 2.338 | 2.343 | 177.8 |

As shown in Table 1, Compounds Ru-1 to Ru-7 prepared in Examples 1 to 7 were determined to have monoclinic or triclinic crystal systems, with space groups P−1, P21/c, or P21/n. In addition, the Ru—C1, Ru—O, and Ru—Cl1 bond distances of Compounds Ru-6 and Ru-7 prepared in Examples 6 and 7 were longer than those of Compounds Ru-1 to Ru-5 prepared in Examples 1 to 5. This is considered to be attributable to the maximized steric interaction due to R11 being an ethyl or isopropyl group and R12 being a benzene ring in Compounds Ru-6 and Ru-7, prepared in Examples 6 and 7, compared to Compounds Ru-1 to Ru-5 prepared in Examples 1 to 5.

These results indicate that Compounds Ru-1 to Ru-7 prepared in Examples 1 to 7 demonstrate that various steric hindrances can be introduced.

### Analysis Example 2: Thermal Stability and Steric Bulk Effect Analysis

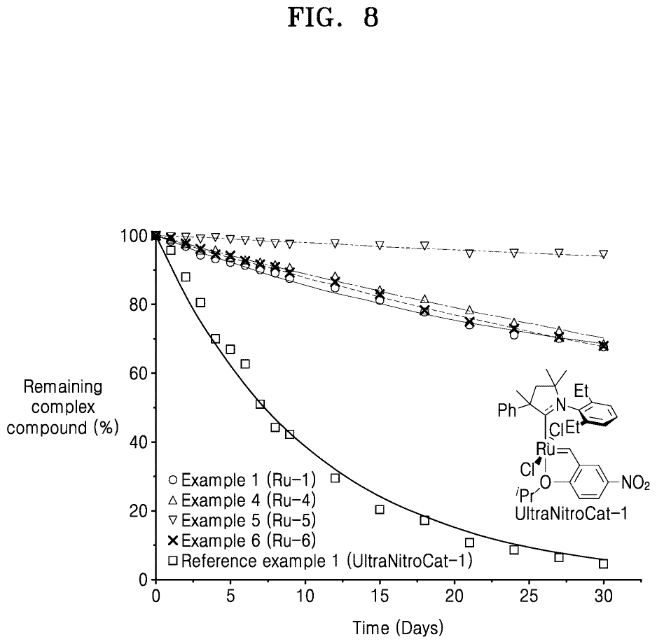

Thermal stability tests were conducted on Compounds Ru-1, Ru-4, Ru-5, and Ru-6 prepared in Examples 1, 4, 5, and 6, and on Compound UltraNitroCat-1 of Comparative Example 1. The thermal stability tests were conducted at 80° C. under air by immersing the compounds in a degassed 0.024 M solution of toluene-d8 (Merck). Thermal decomposition of the compounds was analyzed by monitoring the benzylidene peak using 1H NMR spectroscopy, with 1,3,5-trimethoxybenzene as an internal standard. The results are shown in FIG. 8.

According to FIG. 8, Compounds Ru-1, Ru-4, and Ru-6 prepared in Examples 1, 4, and 6, respectively, retained more than 70% purity after one month. In contrast, Compound UltraNitroCat-1 from Reference Example 1 exhibited only 5% purity under the same conditions. The compound prepared in Example 6 exhibited thermal stability comparable to that of Compound Ru-4 prepared in Example 4, despite containing a complex Blechert-type ligand. This is considered to be attributable to the effect of the robust tricoordinate cyclic alkyl(amino)carbene (CAAC) ligand.

Additionally, based on the thermal stability results of Compounds Ru-1, Ru-4, and Ru-5 prepared in Examples 1, 4, and 5, respectively, the steric bulk effect of the N-aryl substituent was analyzed. Compound Ru-1 prepared in Example 1, which has a methyl group, the smallest substituent, underwent more rapid thermal decomposition, whereas Compound Ru-5 prepared in Example 5, bearing a bulky isopropyl group, retained 95% purity even after one month.

These results confirm that Compounds Ru-1, Ru-4, Ru-5, and Ru-6, prepared in Examples 1, 4, 5, and 6, respectively, exhibit excellent thermal stability as catalysts for ring expansion metathesis polymerization (REMP).

The embodiments have been described above and illustrated in the accompanying drawings to aid in the understanding of the present disclosure. It should be understood, however, that these embodiments are provided solely for illustrative purposes and are not intended to limit the disclosure in any way. Furthermore, it should be understood that the present disclosure is not limited to the descriptions and illustrations set forth herein, as various modifications and changes may be made by those skilled in the art without departing from the scope of the disclosure.

1. A ruthenium complex compound represented by Formula 1: 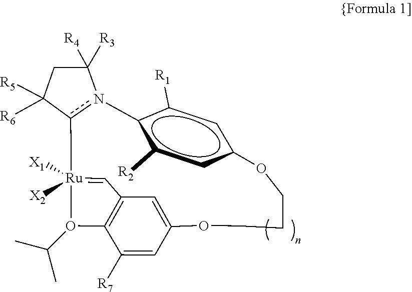
wherein, in the formula,
n is an integer of 1 to 20;
R₁, R₂, R₃, and R₄ are each independently a substituted or unsubstituted C₁-C₁₀ alkyl group;
R₅, R₆, and R₇ are each independently a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof;
the substitution is one in which one hydrogen atom of the hydrogen atoms in R₁, R₂, R₃, R₄, R₅, R₆, and R₇ is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-C₃₀ aryl C₃-C₃₀ heteroaryl group, or a combination thereof; and
X₁ and X₂ are each independently a halogen atom, a substituted benzenethiol ligand, a substituted benzopyrazine ligand, or a combination thereof, and
the substituent is one in which a hydrogen atom of X₁ or X₂ is independently substituted with a halogen group, a thiol group, a dithiol group, an amino group, or a combination thereof.

2. The ruthenium complex compound of claim 1,
wherein n is an integer of 5 to 12.

3. The ruthenium complex compound of claim 1,
wherein R₁, R₂, R₃, and R₄ each independently are an unsubstituted C₁-C₅ alkyl group.

4. The ruthenium complex compound of claim 1,
wherein R₁ and R₂ are the same groups.

5. The ruthenium complex compound of claim 1,
wherein at least one of R₅, R₆, and R₇ is a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof.

6. The ruthenium complex compound of claim 1,
wherein at least one of R₆ and R₇ is a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof.

7. The ruthenium complex compound of claim 1,
wherein X₁ and X₂ are halogen atoms.

8. The ruthenium complex compound of claim 1,
comprising one or more of complex compounds represented by Formulas 2 to 8:

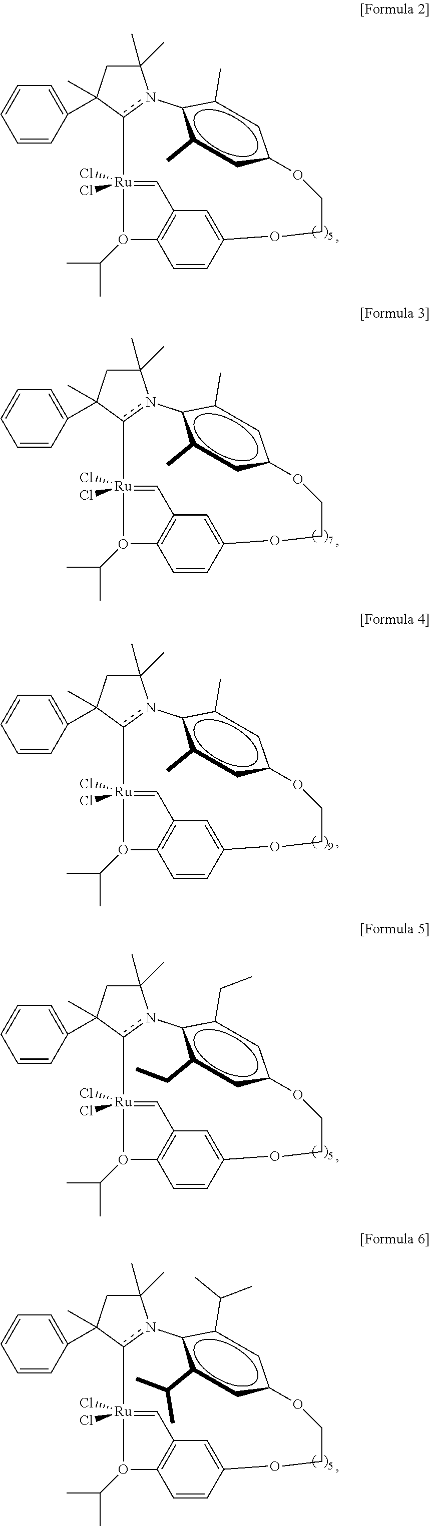

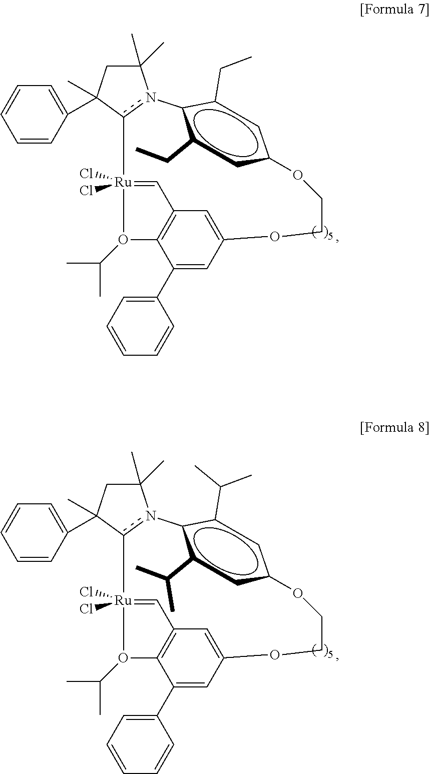

9. The ruthenium complex compound of claim 1,
wherein the complex compound has a monoclinic crystal structure, a triclinic crystal structure, or a combination thereof, and has a P−1 space group, a P2₁/c space group, a P2₁/n space group, or a combination thereof.

10. A catalyst comprising the ruthenium complex compound according to claim 1.

11. The catalyst of claim 10,
Wherein the catalyst is for use in ring expansion metathesis polymerization.

12. The catalyst of claim 10,
wherein the catalyst has a micelle shape, a nanoparticle shape, or a combination shape thereof.

13. The catalyst of claim 10,
wherein the catalyst is for use as a lubricant or a coating agent.

14. A synthesis method for a ruthenium complex compound, the method including synthesizing the ruthenium complex compound according to claim 1 by a reaction of a ruthenium precursor with a cyclic (alkyl)(amino)carbene represented by Formula 9 and linked with an isopropoxystyrene: 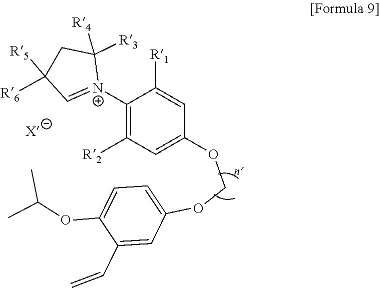
wherein, in the formula,
n′ is an integer of 1 to 20;
R′₁, R′₂, R′₃, and R′₄ are each independently a substituted or unsubstituted C₁-C₁₀ alkyl group;
R′₅ and R′₆ are each independently a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof;
the substitution is one in which one hydrogen atom of the hydrogen atoms in R′₁, R′₂, R′₃, R′₄, R′₅, and R′₆ is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆₋₃₀ aryl C₃-C₃₀ heteroaryl group, or a combination thereof; and
X′ is Cl⁻, Br⁻, I⁻, NO₃⁻, BF₄⁻, CF₃SO₃⁻, C₃₂H₁₂BF₂₄⁻, (C₆F₅)₃B⁻, or a combination thereof.

15. The synthesis method of claim 14,
wherein n′ is an integer of 5 to 12.

16. The synthesis method of claim 14,
wherein the ruthenium precursor comprises a precursor represented by Formula 10: 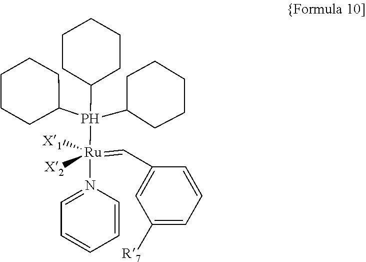
wherein, in the formula,
R₇ is a hydrogen atom, a substituted or unsubstituted C₁-C₃₀ alkyl group, a substituted or unsubstituted C₃-C₃₀ cycloalkyl group, a substituted or unsubstituted C₆-C₃₀ aryl group, a substituted or unsubstituted C₃-C₃₀ heteroaryl group, or a combination thereof; and
the substitution is one in which one hydrogen atom of the hydrogen atoms is independently substituted with a halogen group, a hydroxy group, a nitro group, a cyano group, an amino group, a C₁-C₃₀ alkylamino group, a C₆-C₃₀ arylamino group, a C₆-C₃₀ arylsilyl group, a C₁-C₃₀ alkyl C₆-C₃₀ arylsilyl group, a C₁-C₃₀ alkyl group, a C₁-C₃₀ haloalkyl group, a C₆-C₃₀ aryl C₁-C₃₀ alkyl group, a C₁-C₃₀ alkoxy group, a C₃-C₃₀ cycloalkyl group, a C₆-C₃₀ aryl group, a C₁-C₃₀ alkyl C₆-C₃₀ aryl group, a C₆-C₃₀ aryloxy group, a C₃-C₃₀ heteroaryl group, a C₁-C₃₀ alkyl C₃-C₃₀ heteroaryl group, a C₆-C₃₀ aryl C₃-C₃₀ heteroaryl group, or a combination thereof.

17. The synthesis method of claim 14,
wherein the synthesizing of the ruthenium complex compound comprises a process of synthesizing the ruthenium complex compound through stirring for at least 48 hours at a temperature of 25° C. to 70° C.
